(19) United States
(12) Patent Application Publication
(10) Pub. No.: US 2026/0094322 A1
(43) Pub. Date: Apr. 2, 2026

(54) Auto-generated Visual Representations of Time-Series Data for Better Time-series Understanding

(71) Applicant: Google LLC, Mountain View, CA (US)

(72) Inventors: Mayank Daswani, London (GB); Mathias M. Bellaiche, London (GB); Marc Peter Tarca Wilson, London (GB); Shruthi Prabhakara, Sunnyvale, CA (US)

(21) Appl. No.: 19/342,949

(22) Filed: Sep. 29, 2025

Related U.S. Application Data
(60) Provisional application No. 63/700,193, filed on Sep. 27, 2024.

(51) Int. Cl. G06T 11/20; G06F 8/35; G06F 9/451; G06T 3/40

(52) U.S. Cl. CPC G06T 11/26; G06F 9/451; G06T 3/40; G06F 8/35; G06T 2200/24; G06T 2210/41

(57) ABSTRACT

A method of interpreting time-series data is provided. This method includes receiving a prompt containing at least one time series of data. The method may also include extracting, using at least one machine learning model, the at least one time series of data from the prompt. Further, the method may include generating, using the at least one machine learning model based on the at least one time series of data, at least one plot representative of the at least one time series of data. Even further, the method may include applying the at least one machine learning model to the prompt and the at least one plot to generate an output responsive to the prompt.

### CROSS-REFERENCE TO RELATED APPLICATIONS

The present application is a non-provisional patent application claiming priority to U.S. Provisional Patent Application No. 63/700,193, filed Sep. 27, 2024, the contents of which are hereby incorporated by reference.

### BACKGROUND

Multimodal models like GPT4 and Gemini are trained to understand visual information natively. However, they are not specifically trained to understand time-series data—in particular, the tokenizers for large language models (LLMs) are not well-suited for representing large sequences of floating point numbers. The present disclosure aims to address the issues with machine learning models understanding and interpreting time-series data.

### SUMMARY

In one aspect, a method of interpreting time-series data is provided. This method may include a step of receiving a prompt containing at least one time series of data. The method may also include a step of extracting, using at least one machine learning model, the at least one time series of data from the prompt. Further, the method may include generating, using the at least one machine learning model based on the at least one time series of data, at least one plot representative of the at least one time series of data. Even further, the method may include applying the at least one machine learning model to the prompt and the at least one plot to generate an output responsive to the prompt.

In another aspect a computing device is provided. The computing device may be configured to receive a prompt containing at least one time series of data. The computing device may also be configured to extract, using at least one machine learning model, the at least one time series of data from the prompt. Further, the computing device may be configured to generate, using the at least one machine learning model based on the at least one time series of data, at least one plot representative of the at least one time series of data. Even further, the computing device may be configured to apply the at least one machine learning model to the prompt and the at least one plot to generate an output responsive to the prompt.

In a further aspect, a non-transitory computer-readable medium comprising program instructions executable by at least one processor to perform functions is provided. These functions may include receiving a prompt containing at least one time series of data, extracting, using at least one machine learning model, the at least one time series of data from the prompt, generating, using the at least one machine learning model based on the at least one time series of data, at least one plot representative of the at least one time series of data, and applying the at least one machine learning model to the prompt and the at least one plot to generate an output responsive to the prompt.

### BRIEF DESCRIPTION OF THE FIGURES

The above, as well as additional, features will be better understood through the following illustrative and non-limiting detailed description of example embodiments, with reference to the appended drawings.

FIG. 1 illustrates a method, according to an example embodiment.

FIG. 2A illustrates prompts and code snippets corresponding to a target dataclass for functional form identification, according to an example embodiment.

FIG. 2B illustrates prompts and code snippets corresponding to a plot prompt for functional form identification, according to an example embodiment.

FIG. 2C illustrates prompts and code snippets corresponding to a text prompt for functional form identification, according to an example embodiment.

FIG. 2D illustrates prompts and code snippets corresponding to a text and plot prompt for functional form identification, according to an example embodiment.

FIG. 2E illustrates prompts and code snippets corresponding to a plot and text prompt for functional form identification, according to an example embodiment.

FIG. 3A illustrates prompts and code snippets corresponding to a target dataclass for correlation of two lines, according to an example embodiment.

FIG. 3B illustrates prompts and code snippets corresponding to a plot prompt for correlation of two lines, according to an example embodiment.

FIG. 3C illustrates prompts and code snippets corresponding to a text prompt for correlation of two lines, according to an example embodiment.

FIG. 4A illustrates prompts and code snippets corresponding to a target dataclass for 2D data clustering, according to an example embodiment.

FIG. 4B illustrates prompts and code snippets corresponding to a plot prompt for 2D data clustering, according to an example embodiment.

FIG. 4C illustrates prompts and code snippets corresponding to a text prompt for 2D data clustering, according to an example embodiment.

FIG. 5A illustrates prompts and code snippets corresponding to a target dataclass for derivative identification, according to an example embodiment.

FIG. 5B illustrates prompts and code snippets corresponding to a plot prompt for derivative identification, according to an example embodiment.

FIG. 5C illustrates prompts and code snippets corresponding to a text prompt for derivative identification, according to an example embodiment.

FIG. 6A illustrates prompts and code snippets corresponding to a target dataclass for quadratic derivative identification, according to an example embodiment.

FIG. 6B illustrates prompts and code snippets corresponding to a plot prompt of zero-shot without extended reasoning for quadratic derivative identification, according to an example embodiment.

FIG. 6C illustrates prompts and code snippets corresponding to a text prompt of zero-shot without extended reasoning for quadratic derivative identification, according to an example embodiment.

FIG. 6D illustrates prompts and code snippets corresponding to a plot prompt of zero-shot with extended reasoning for quadratic derivative identification, according to an example embodiment.

FIG. 6E illustrates prompts and code snippets corresponding to a text prompt of zero-shot with extended reasoning for quadratic derivative identification, according to an example embodiment.

FIG. 6F illustrates a first section of prompts and code snippets corresponding to a plot prompt of few-shot for quadratic derivative identification, according to an example embodiment.

FIG. 6G illustrates a second section of prompts and code snippets corresponding to a plot prompt of few-shot for quadratic derivative identification, according to an example embodiment.

FIG. 6H illustrates a first section of prompts and code snippets corresponding to a text prompt of few-shot for quadratic derivative identification, according to an example embodiment.

FIG. 6I illustrates a second section of prompts and code snippets corresponding to a text prompt of few-shot for quadratic derivative identification, according to an example embodiment.

FIG. 7A illustrates prompts and code snippets corresponding to a target dataclass for fall detection from IMU data, according to an example embodiment.

FIG. 7B illustrates prompts and code snippets corresponding to a plot prompt for fall detection from IMU data, according to an example embodiment.

FIG. 7C illustrates prompts and code snippets corresponding to a text prompt for fall detection from IMU data, according to an example embodiment.

FIG. 8A illustrates prompts and code snippets corresponding to a target dataclass for activity recognition from IMU data, according to an example embodiment.

FIG. 8B illustrates prompts and code snippets corresponding to a plot prompt for activity recognition from IMU data, according to an example embodiment.

FIG. 8C illustrates prompts and code snippets corresponding to a text prompt for activity recognition from IMU data, according to an example embodiment.

FIG. 9A illustrates a table of text-based functional form identification ablation results: modifying value separator for different numbers of points, according to an example embodiment.

FIG. 9B illustrates a table of text-based functional form identification ablation results: modifying value separator for different noise levels, according to an example embodiment.

FIG. 9C illustrates a table of text-based functional form identification ablation results: modifying value separator for different function classes, according to an example embodiment.

FIG. 9D illustrates a table of text-based functional form identification ablation results: modifying floating point fixed precision for different numbers of points, according to an example embodiment.

FIG. 9E illustrates a table of text-based functional form identification ablation results: modifying floating point fixed precision for different noise levels, according to an example embodiment.

FIG. 9F illustrates a table of text-based functional form identification ablation results: modifying floating point fixed precision for different function classes, according to an example embodiment.

FIG. 9G illustrates a table of text-based functional form identification ablation results: rescaling values for different numbers of points, according to an example embodiment.

FIG. 9H illustrates a table of text-based functional form identification ablation results: rescaling values for different noise levels, according to an example embodiment.

FIG. 9I illustrates a table of text-based functional form identification ablation results: rescaling values for different function types, according to an example embodiment.

FIG. 10A illustrates a table of plot-based functional form identification ablation results: modifying figure dpi for different numbers of points, according to an example embodiment.

FIG. 10B illustrates a table of plot-based functional form identification ablation results: modifying figure dpi for different noise levels, according to an example embodiment.

FIG. 10C illustrates a table of plot-based functional form identification ablation results: modifying figure dpi for different function classes, according to an example embodiment.

FIG. 10D illustrates a table of plot-based functional form identification ablation results: modifying figure size for different numbers of points, according to an example embodiment.

FIG. 10E illustrates a table of plot-based functional form identification ablation results: modifying figure size for different noise levels, according to an example embodiment.

FIG. 10F illustrates a table of plot-based functional form identification ablation results: modifying figure size for different function classes, according to an example embodiment.

FIG. 10G illustrates a table of plot-based functional form identification ablation results: modifying plotting style for different numbers of points, according to an example embodiment.

FIG. 10H illustrates a table of plot-based functional form identification ablation results: modifying plotting style for different noise levels, according to an example embodiment.

FIG. 10I illustrates a table of plot-based functional form identification ablation results: modifying plotting styles for different function classes, according to an example embodiment.

FIG. 10J illustrates a table of plot-based functional form identification ablation results: modifying color palette for different numbers of points, according to an example embodiment.

FIG. 10K illustrates a table of plot-based functional form identification ablation results: modifying color palette for different noise levels, according to an example embodiment.

FIG. 10L illustrates a table of plot-based functional form identification ablation results: modifying color palette for different function classes, according to an example embodiment.

FIG. 10M illustrates a table of plot-based functional form identification ablation results: modifying plot makers for different numbers of points, according to an example embodiment.

FIG. 10N illustrates a table of plot-based functional form identification ablation results: modifying plot makers for different noise levels, according to an example embodiment.

FIG. 10O illustrates a table of plot-based functional form identification ablation results: modifying plot makers for different function classes, according to an example embodiment.

FIG. 10P illustrates a table of plot-based functional form identification ablation results: modifying plot maker sizes for different numbers of points, according to an example embodiment.

FIG. 10Q illustrates a table of plot-based functional form identification ablation results: modifying plot maker sizes for different noise levels, according to an example embodiment.

FIG. 10R illustrates a table of plot-based functional form identification ablation results: modifying plot maker sizes for different function classes, according to an example embodiment.

FIG. 10S illustrates a table of plot-based functional form identification ablation results: modifying plot components for different numbers of points, according to an example embodiment.

FIG. 10T illustrates a table of plot-based functional form identification ablation results: modifying plot components for different noise levels, according to an example embodiment.

FIG. 10U illustrates a table of plot-based functional form identification ablation results: modifying plot components for different function classes, according to an example embodiment.

FIG. 10V illustrates a table of plot-based functional form identification ablation results: modifying temperature for different numbers of points, according to an example embodiment.

FIG. 10W illustrates a table of plot-based functional form identification ablation results: modifying temperature for different noise levels, according to an example embodiment.

FIG. 10X illustrates a table of plot-based functional form identification ablation results: modifying temperature for different function classes, according to an example embodiment.

FIG. 11 illustrates plots used for functional form identification task examples chosen at random representing at various noise levels, according to an example embodiment.

FIG. 12 illustrates plots used for correlation of two lines task examples chosen at random representing positive and negative correlations at various noise levels, according to an example embodiment.

FIG. 13 illustrates plots used for 2D cluster counting task examples chosen at random representing varying cluster parameterizations, according to an example embodiment.

FIG. 14 illustrates plots used for the derivative identification task example, according to an example embodiment.

FIG. 15 illustrates plots used for the quadratic derivative identification task, according to an example embodiment.

FIG. 16 illustrates a table showing a comparison of most performant foundation models with task-specific fall detection support vector machine (SVM), according to an example embodiment.

FIG. 17 illustrates a table of percent differences in median plot performances relative to median text performances, according to example embodiments.

FIG. 18 illustrates plots of functional form identification performance over various dataset parameters, according to an example embodiment.

FIG. 19 illustrates plots of correlation of two lines performance over various dataset parameters, according to an example embodiment.

FIG. 20 illustrates plots of 2D cluster counting performance over various dataset parameters (lower is better), according to an example embodiment.

FIG. 21 illustrates plots of derivative identification performance over various dataset parameters, according to an example embodiment.

FIG. 22 illustrates plots of zero-shot quadratic derivative identification performance over various dataset parameters, according to an example embodiment.

FIG. 23 illustrates plots of zero-shot synthetic data results showing plot- and text-based accuracy (or MAE for the cluster counting task) distributions for all models, according to an example embodiment.

FIG. 24 illustrates a table of a summary of results across all tasks, according to an example embodiment.

FIG. 25 illustrates a table of a summary of eight tasks studied, according to an example embodiment.

FIG. 26 illustrates a plot of accuracy for few-shot quadratic derivative identification, according to an example embodiment.

FIG. 27 illustrates a plot with results of a fall detection task across various models, according to an example embodiment.

FIG. 28 illustrates a plot with results of an activity detection task across various models, according to an example embodiment.

FIG. 29 illustrates a plot with results of a readiness task for Gemini models, according to an example embodiment.

All the figures are schematic, not necessarily to scale, and generally only show parts which are necessary to elucidate example embodiments, wherein other parts may be omitted or merely suggested.

### DETAILED DESCRIPTION

### I. Overview

Examples described herein enable a machine learning model, such as a vision language model, to better interpret time-series data to respond to a user prompt by generating a plot for the model's own consumption. As illustrated in the present disclosure, the model may perform better on a variety of output generation tasks related to a variety of different types of time-series data when provided with a visual plot rather than raw numerical data. In some examples, the plot may also be displayed to a user to provide an intuitive understanding of the model's reasoning. In some such examples, a mechanism may be provided via a user interface to enable a user to adjust the plot before consumption by the model. In further examples, the model may iteratively adjust the plot to improve the interpretability of the plot before consuming the plot to generate an output.

In some examples, the input prompt may be provided as a simple prompt that contains a long string of numbers, among other instructions. As an initial matter, a machine learning model, such as a large language model (LLM) or multimodal model, may be run to classify the prompt as being time-series relevant or not. A prompt may be classified as time-series relevant when the prompt includes one or multiple sequences of numerical data. If the prompt is determined to be time-series relevant, further processing may be performed to extract the time series and generate a plot to enable the model to better interpret the prompt to generate an output.

A machine learning model, such as a LLM or multimodal modal, may extract relevant data from a prompt to be plotted. In some examples, in order to avoid the model outputting a large number of tokens, a programmatic approach may be applied to extract at least one time series of data. More specifically, the model may be prompted for program code using regular expressions that can extract the time-series data from the input. A separate summary of the user request without numerical data may also be separately generated. For instance, below is an example user request (referred to as user_request in later prompts):
Tell me if the following ECG signal shows atrial fibrillation:
Input_waveform: 3.0, 2.5, 3.44, 1.2323,
A meta-prompt may then be generated as follows:
Given the following user request below, write python code to get the data from the request using regexes, and place it in a JSON object.

Additionally, generate a summary of the user's request without any numerical data and put it under the “summary” key in the JSON object. Ensure that this summary has all information required to generate good plotting code for the request.
{{user_request}}
The meta-prompt may be provided to a machine learning model, such as a LLM or multimodal model, resulting in the following program code:

```
  import json
  import re
  user_request = “Tell me if the following ECG signal shows atrial
fibrillation:\n\nInput_waveform: 3.0, 2.5, 3.44, 1.2323, .....”
  # Extract data using regex
  waveform_data = re.search(r“Input_waveform:\s*(.+)”,
  user_request).group(1)
  # Convert data to a list of floats
  waveform_values = [float(x.strip( )) for x in waveform_data.split(“,”)
  if x.strip( )]
  # Generate summary
  summary = “Determine if an ECG signal indicates atrial fibrillation.”
  # Create JSON object
  output_json = {
    “waveform_data”: waveform_values,
    “summary”: summary
  }
  # Print the JSON object
  print(json.dumps(output_json))
  > {
    “waveform_data”: <numbers>,
    “summary”: <summary of the request>
  }
```

The model may therefore generate program code which can be used to extract the time-series data without requiring separate tokens for each element of the time series. In some examples, the program code may be guaranteed to be valid code (e.g., valid Python code) by making use of a structured prompting approach. In some examples, the program code may be executed to extract the time series and place it in a predetermined location (e.g., a dictionary following the JSON schema).

The model may then generate a plot representative of the time series. In some examples, the model may generate plotting code. In some examples, in order to minimize the costs of token generation, a summary and JSON keywords may be provided back to the model, and the model may be asked to generate the plotting code. An example input to a model to generate the plotting code is provided below:

Use the following summary of a task+description of the keys in a dictionary to generate some plotting code. Assume the data will be present within a python variable called data with the provided JSON object keys.

Task: Determine if an ECG signal indicates atrial fibrillation.

Keys present in dictionary: “waveform_data”

The model may therefore generate output code which may be executed to generate a plot (e.g., a visual representation of the time-series data). Example plotting code generated by the model is provided below:

import matplotlib.pyplot as plt
ecg_signal = data[‘waveform_data’]
time_axis = range(len(ecg_signal))
# Plot the ECG signal
plt.figure(figsize=(15, 5))
plt.plot(time_axis, ecg_signal)
plt.title(‘ECG Signal’)
plt.xlabel(‘Time (samples)’)
plt.ylabel(‘Amplitude’)
plt.grid(True)
plt.show( )

The plotting code may then be executed to generate one or more relevant plots. In some examples, the one or more plots may be converted to bytes and those bytes may be fed back into the model. The original prompt may therefore be fed back into the model with the plot(s) instead of raw text representing the time-series data. An example input to a model to use a generated plot along with the initial prompt to generate an output is provided below:
Tell me if the following ECG signal shows atrial fibrillation:
Input_waveform: {{waveform_plot}}

In some examples, a model may iterate over a generated plot one or more times to refine the plot before processing the plot to generate an output. More specifically, a plot may be generated in a format that the model can interpret using its own vision encoder. The model may then be instructed to use its own judgment to determine whether to generate one or more new plots of data. For example, generating a new plot can involve zooming-in to see some part of the plot more closely, plotting an alternate representation (e.g. a Fourier transform), or adding one or more additional visual aids to the plot. In some examples, this iteration can then be repeated some number of times, until the model determines that a final plot is sufficient to interpret to generate an output.

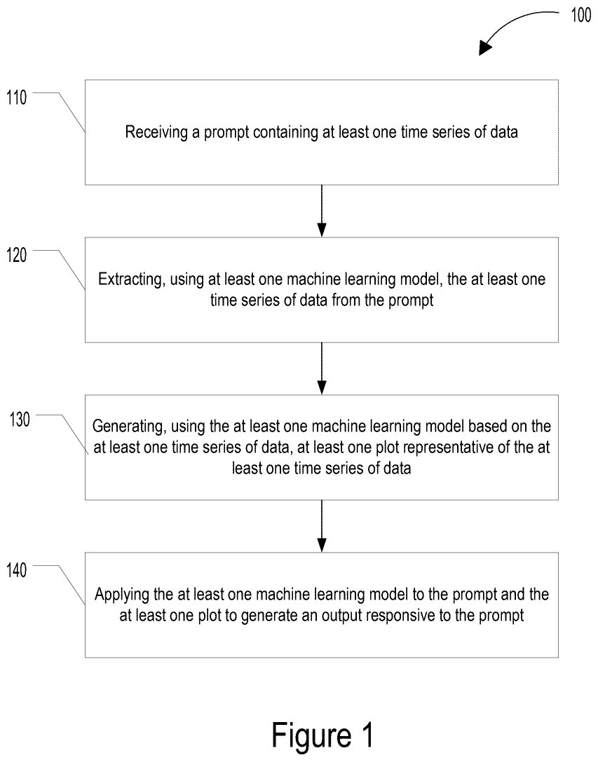

FIG. 1 illustrates a method 100, according to an example embodiment. This method 100 includes a function 110 of receiving a prompt containing at least one time series of data. In some such examples, the prompt may be received via a user interface of a computing device. In some examples, the prompt may be a long string of text, including one or more sequences of numbers. In other examples, the user interface may enforce a particular structure, for instance by providing one or more input fields to input time series of numerical data.

The method 100 may further include a function 120 of extracting, using at least one machine learning model, the at least one time series of data from the prompt. In some examples, the extraction may only be performed after determining that the prompt is time-series relevant using the model. In some examples, a programmatic approach may be used to extract at least one time series without requiring separate tokens for each element of the time series. In particular, program code may be generated to perform the extraction. In some examples, generating the program code involves applying regular expressions to identify locations of at least one time series in the prompt (e.g., start and stop points for one or more time series).

The method 100 may further include a function 130 of generating, using at least one machine learning model, at least one plot representative of at least one time series of data. The plot may be generated in a format interpretable by a vision encoder of a model (e.g., as bytes of image data). More generally, the plot may be a visual representation which enables the model to more accurately process the prompt from the user.

In further examples, the model may generate an application programming interface (API) call to a separate plotting tool. The model may then receive the output from the API call to use as context for generating an output responsive to the prompt.

In some examples, the model may iteratively refine a plot one or more times before attempting to interpret the plot to generate an output. This refinement may involve adjusting of a plot. In some examples, adjusting of a plot may involve adjusting a zoom of the plot (e.g., zooming in or zooming out to focus on relevant information). In some examples, adjusting of a plot may involve applying a time-series analytic method, such as a Fourier transform, a short-time Fourier transform (STFT), a spectrogram, or a Mel spectrogram. In some examples, the adjusting of a plot may involve removing a portion of the time series of data (e.g., removing one or more extraneous elements that disrupt the usefulness of the plot). In some examples, the adjusting of a plot may involve adjusting a sampling rate (e.g., increasing or decreasing the sampling rate to provide a more useful plot). In some examples, the adjusting of a plot may involve adjusting one or more axis bounds of the plot (e.g., to cut off portions of the plot that are not helpful to interpret the data).

In some examples, a plot may be displayed to a user via a user interface of a computing device. A displayed plot may provide an intuitive understanding of a model's reasoning. In some examples, the user interface may enable user input to adjust the plot before feeding the plot into the model to generate an output responsive to a prompt. For example, the user input may adjust the plot in line with any of the methodologies by which the model may itself adjust the plot in the examples described above. In further examples, any program code generated by the model (e.g., any of the previously illustrated segments of program code) may be displayed to a user via a user interface to enable user adjustment before the model ultimately generates an output responsive to the prompt.

The method 100 may further include a function 140 of applying at least one machine learning model to the prompt and at least one plot to generate an output responsive to the prompt. In some examples, the same model may perform each function of the method. For example, a multimodal model such as a vision language model may perform each function of the method. In other examples, different models may be used for different functions of the method. For example, a language model such as a LLM may be used to extract time series data from a prompt and generate a plot. Subsequently, a multimodal model such as a vision language model may be used to interpret the plot and the prompt to generate an output.

A number of use cases involving different types of time-series data are contemplated for application of the methodology described herein.

In some examples, a time series of data includes inertial motion unit (IMU) data for a computing device. The output may then relate to activity recognition. In such examples, the computing device may be a wearable device such as a smartwatch. The activity recognition may involve fall detection (e.g., classifying a user session into different fall states). Further examples may involve evaluating readiness from wearable measures of training intensity. More specifically, a user may be classified into over- or under-training based on a month of daily exercise history.

In further examples, a time series of data may include electrocardiogram (ECG) data. ECG data may be evaluated to provide an output responsive to a prompt about a medical state of a user, such as to evaluate whether the user has atrial fibrillation.

In further examples, a time series of data may include heart rate data. For example, the data may be evaluated to respond to a prompt about beats per minute to evaluate whether a user has a healthy heart rate.

In further examples, a time series of data may include photoplethysmogram (PPG) data. For example, this data may be used to respond to a prompt to evaluate heart rate, respiration, or blood pressure of a user.

In further examples, a time series of data may relate to building operations. For example, the data may be used to respond to a prompt to evaluate temperatures at different times/locations for purposes of controlling heating, ventilation, and air conditioning (HVAC).

Yet further examples involve alternative representations besides visual plot representations. More specifically, audio data may be processed to produce audio waveform data which may then be consumed by a model. Audio waveform data may be more easily interpretable by a model to respond to a prompt (e.g., to identify a song) than by processing the sound data directly.

Examples described herein provide computational benefits in the form of reduced memory usage on a computing device. More specifically, methods which directly extract and process a large time series of data may require separate input tokens for each individual element (each number) in the time series. In some examples, this may involve hundreds or thousands of individual elements stored in memory. By contrast, programmatic methods as described herein may be used to identify and extract time series without requiring separate tokens for each element. For example, start and stop points may be identified using regular expressions to extract a time series directly from a prompt. Such approaches may also increase accuracy by avoiding incorrect relaying of individual elements of a time series.

Moreover, reduced memory benefits may also be obtained by providing bytes of data representing chunks of a visual plot rather than individual elements of a time series to a model when generating an output. For instance, a time series which contains a huge number of elements may require significantly more memory to input each individual element of the time series to a model rather than inputting each byte of a plot with sufficient granularity to enable interpretation of a prompt.

In further examples, computational benefits may be obtained in the form of reduced processing power and/or reduced processing time. More specifically, processing each individual element of a long time series may require significant computational cost to generate and/or process individual tokens corresponding to each element of the time series. By contrast, the compute cost to generate and/or process each byte of a visual plot may be significantly less, as relatively fewer bytes may be needed for the model to interpret a visual plot to provide an output responsive to a prompt.

While multimodal foundation models can now natively work with data beyond text, they remain underutilized in analyzing the considerable amounts of multidimensional time-series data in fields like healthcare, finance, and social sciences, representing a missed opportunity for richer, data-driven insights. This present disclosure proposes a simple but effective method that leverages the existing vision encoders of these models to “see” time-series data via plots, avoiding the need for additional, potentially costly, model training. These empirical evaluations show that this approach may outperform providing the raw time-series data as text, with the additional benefit that visual time-series representations demonstrate up to a 90% reduction in model API costs. This hypothesis is considered through synthetic data tasks of increasing complexity, progressing from simple functional form identification on clean data, to extracting trends from noisy scatter plots. To demonstrate generalizability from synthetic tasks with clear reasoning steps to more complex, real-world scenarios, the approach is applied to consumer health tasks—specifically fall detection, activity recognition, and readiness assessment—which involve heterogeneous, noisy data and multi-step reasoning. The overall success in plot performance over text performance (up to an 120% performance increase on zeroshot synthetic tasks, and up to 150% performance increase on real-world tasks), across both GPT and Gemini model families, highlights this approach's potential for making the best use of the native capabilities of foundation models.

The hypothesis that multimodal models understand time-series data better through their vision encoders than through the textual representation of the sequences is explored using synthetic and real-world data experiments. The synthetic data experiments allow for close control of the difficulty of tasks through the addition of noise and by changing the number of points in each function. A mix of tasks that require a differing number of reasoning steps are also used, as well as different kinds of reasoning, to get a correct answer.

Fall detection and activity recognition are both real-world tasks that make use of inertial measurement units (IMUs) from mobile phones or wearable devices. IMUs are 6-dimensional waveforms consisting of 3 axes of acceleration data and 3 axes of angular velocity data. The fall detection task consists of classifying an IMU waveform segment into one of three classes: Fall, Active Daily Living (ADL) or Near Fall (a hard negative class). The activity recognition task consists of classifying a waveform segment into one of five classes: Sitting, Standing, Walking, Cycling or Stairs.

By contrast, the readiness assessment task is a binary classification of 28 days of training load data from a single user into undertraining or overtraining. Because of the tabular nature of the data, the plot version is presented as a bar plot. This may not be the ideal setting for this method—it may be most beneficial when the amount of data exceeds what's reasonably presentable in a text table.

These findings show that when using this plot-based approach, multimodal models may perform much better on tasks where the result is dependent on understanding the overall trend. Specific examples of this are found when identifying the functional form, the number of clusters, the correlation between two functions, and on the real-world pattern-recognition tasks of activity recognition and fall detection. For example, GPT40 using plots on the functional form identification task shows a performance improvement of 122% over the text representation. On other tasks that require more advanced reasoning such as multi-step or connecting trend shapes with sequence magnitudes (e.g. identifying derivatives), and on tasks with tabular data (e.g. readiness assessment), the performance is equivalent. However, there is a substantial cost difference between vision and text prompts, which is particularly pronounced on very large context tasks, as the same information in a long sequence that requires many (10,000's to 100,000's) text tokens can be represented in one plot with much fewer (100's to 1000's) vision tokens. While vision tokens are more expensive than text tokens, the difference in unit cost is much lower than the orders of magnitude difference in overall prompt length, so that the total cost is still much lower using the vision approach. This difference is particularly relevant on tasks where extensive few-shots are required to achieve good performance, and optimizing token efficiency translates to significant resource savings. Not only may this plot-based approach achieve better performance while being more efficient, it also may be generalizable across any task that involves reasoning about a long, complex time-series as it requires zero additional model training.

The term “time-series understanding” is used in this disclosure to distinguish from time-series forecasting. Time-series forecasting predicts future data points based on points seen so far, whereas the primary focus of this disclosure is in the setting where the time-series data is connected to a multimodal model for further analysis. In particular, it is an objective of the present disclosure to show that multimodal models can reason about overall trends, the relationship between multiple time-series, overall clustering of data, and other time-series understanding tasks.

Using multimodal models to generate any of the questions themselves is deliberately avoided as this can introduce biases during evaluation that are hard to account for (e.g. favoring their own output).

LLMTime (Gruver et al., Advances in Neural Information Processing Systems, 36, 2024) shows that with careful tokenization, text-only LLMs can perform well at forecasting tasks. In the present disclosure, ablations are performed based on those methods and the best tokenizations are selected accordingly for the text baselines.

In this present disclosure, it is shown that one may achieve much better performance from a foundation model by exploiting its native multimodal capabilities compared to using only text. It is shown that simply plotting the data is at the very least an easy first step, and might be a helpful approach when training a task-specific encoder from scratch may not be feasible due to the requirements on having additional paired data, compute and expertise.

The visual prompting method was evaluated on both synthetic data and real-world use-cases. Synthetic data allows for control of the difficulty of the task by adding noise and altering the number of data points, and for investigation of specific kinds of reasoning in isolation. The synthetic tasks were chosen to align with the different steps of reasoning that may be required for the representative realworld use cases that were tested on. These include understanding the local and global longitudinal signatures (trend and magnitude) of a time-series, and potentially comparing it with several other time-series (as in the case of multidimensional sensing).

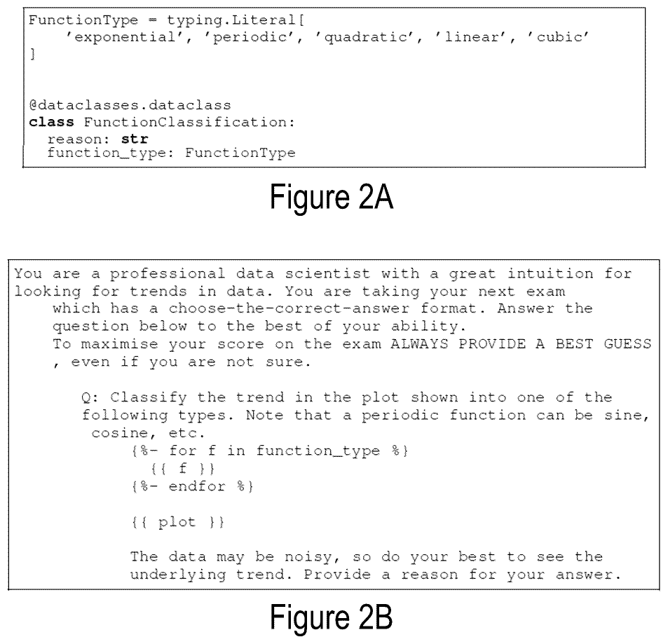

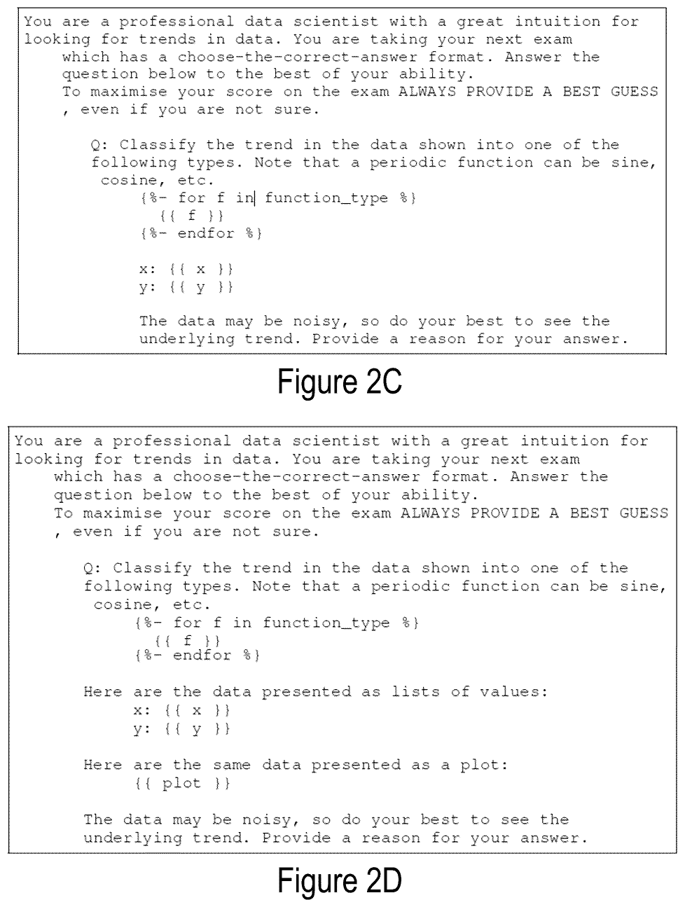

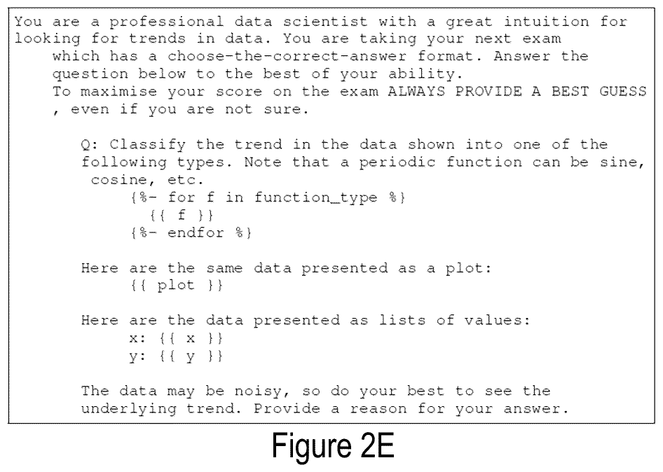

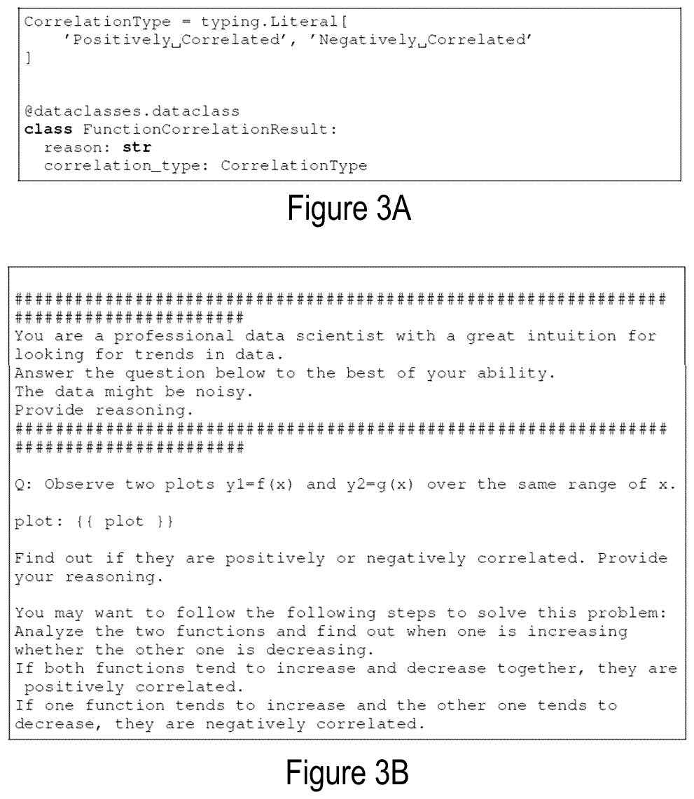

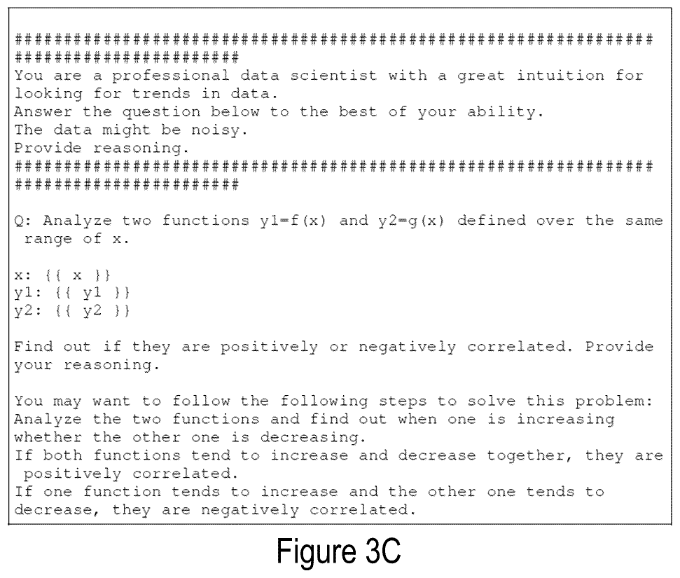

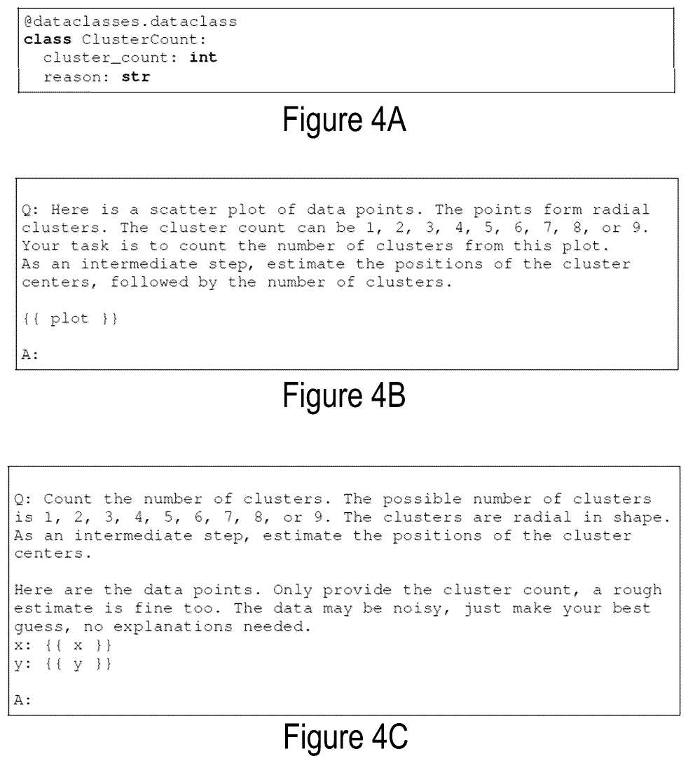

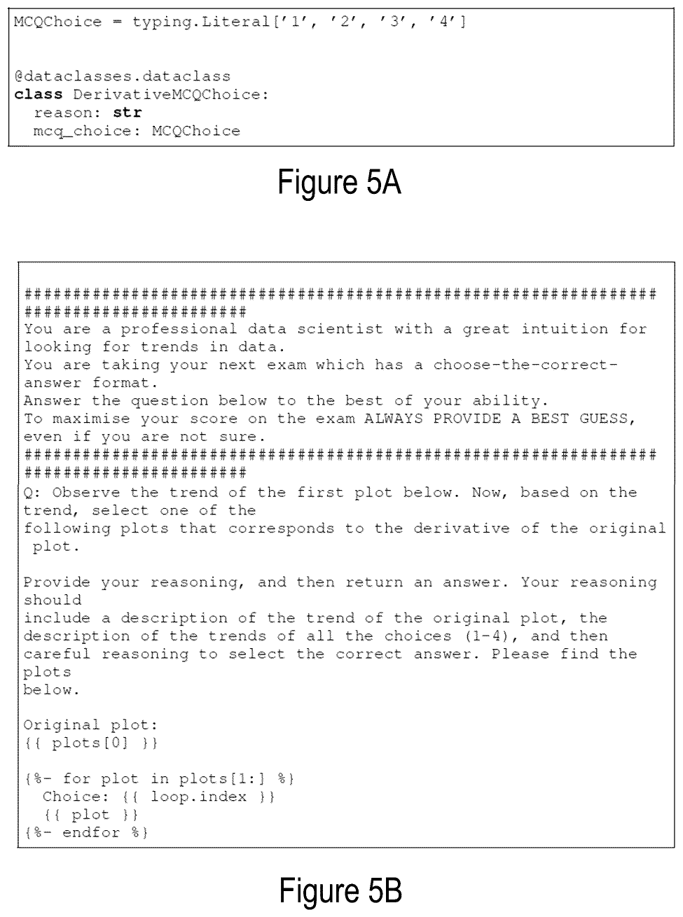

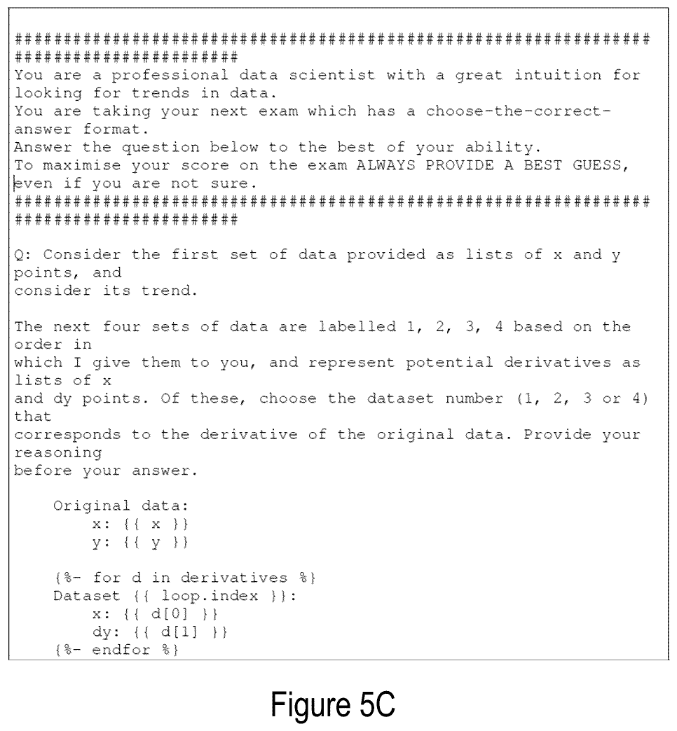

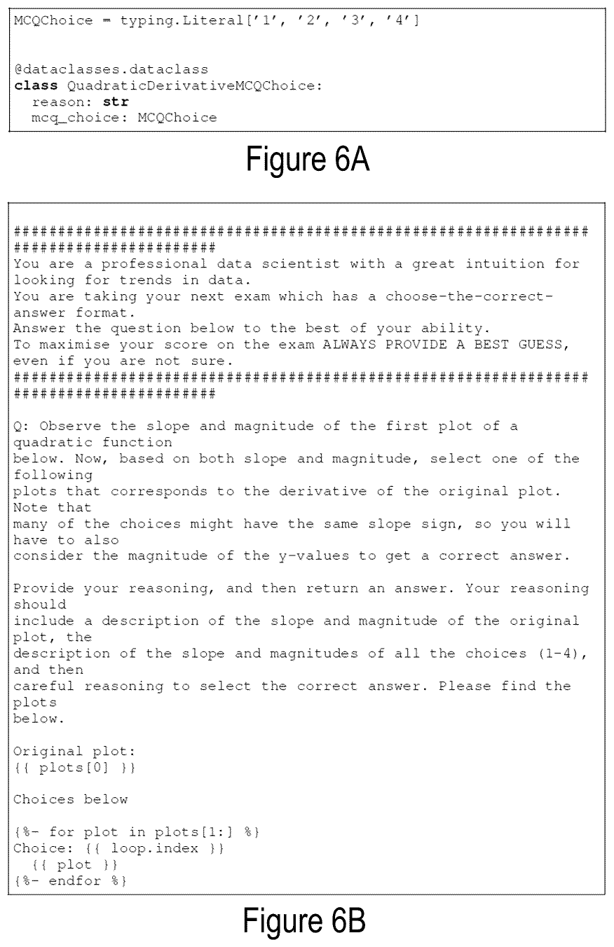

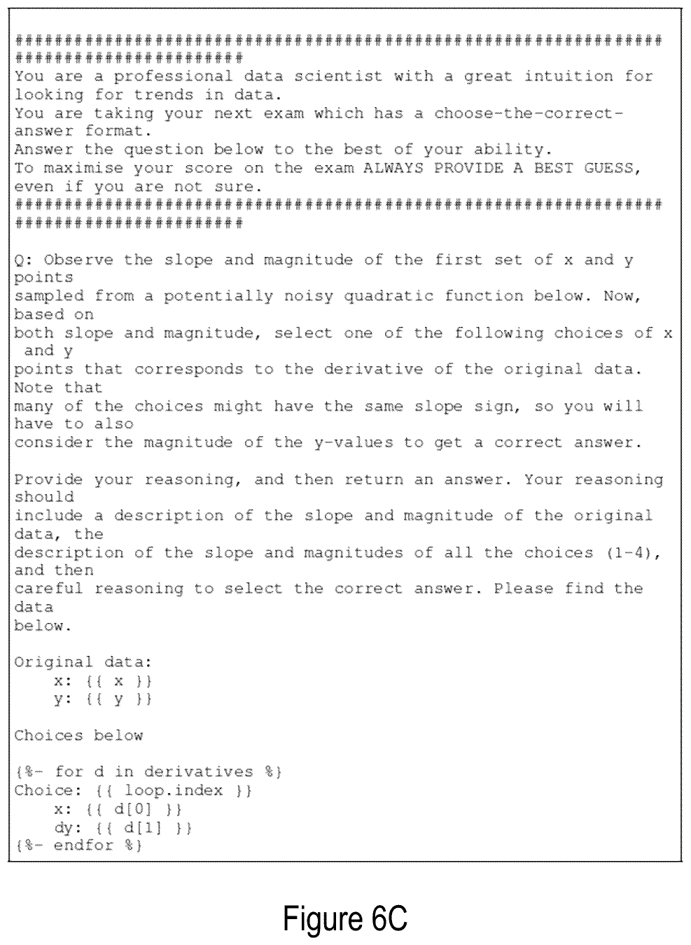

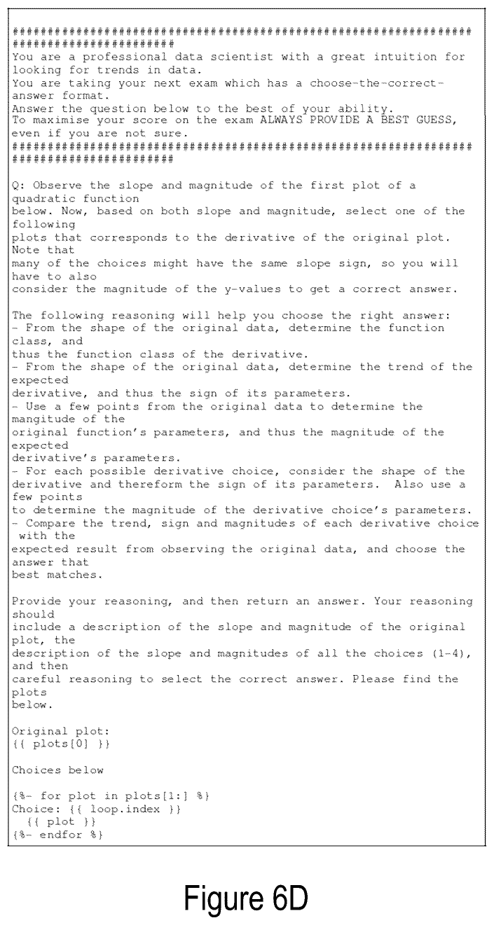

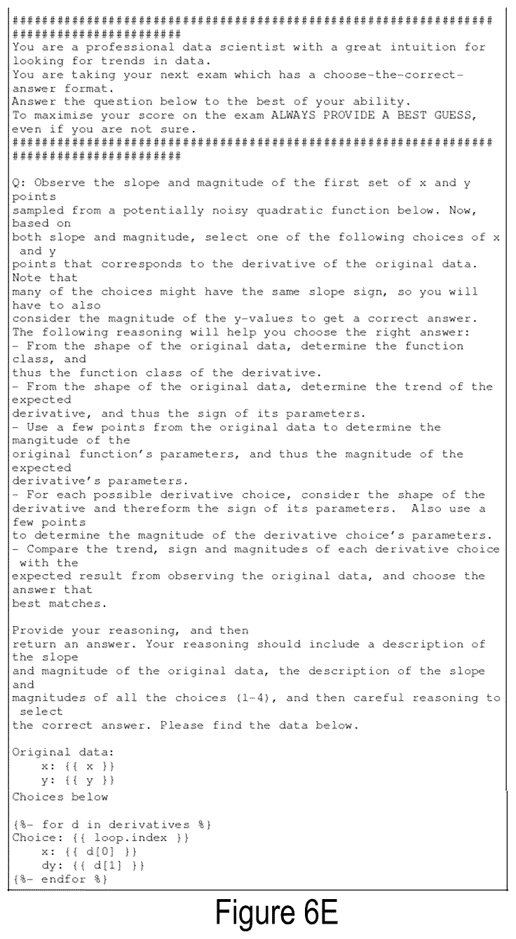

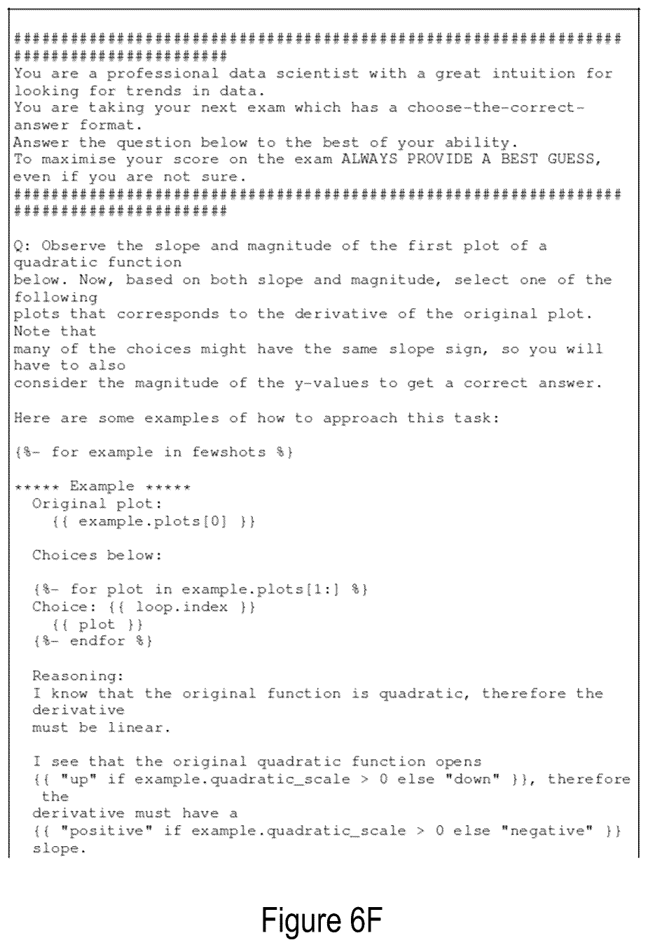

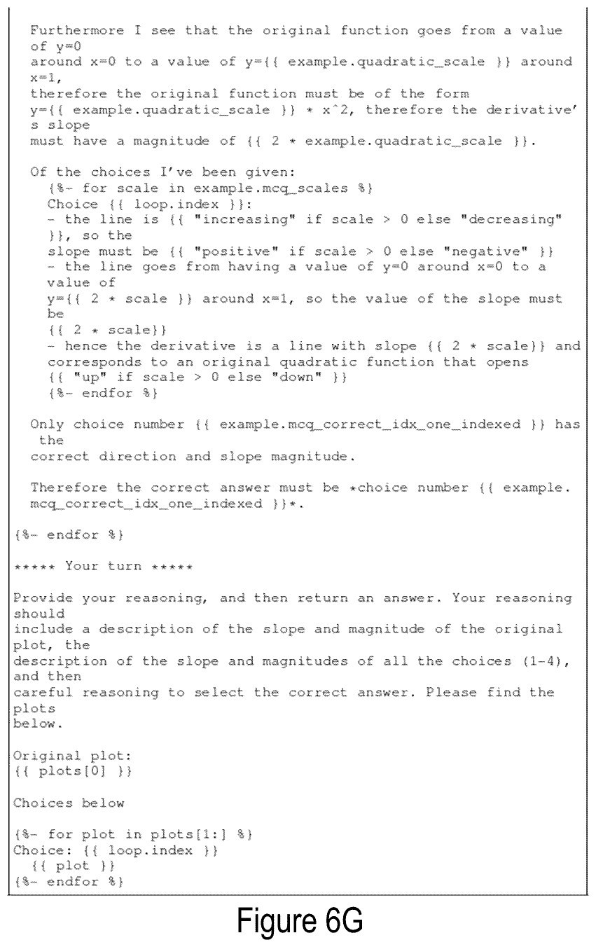

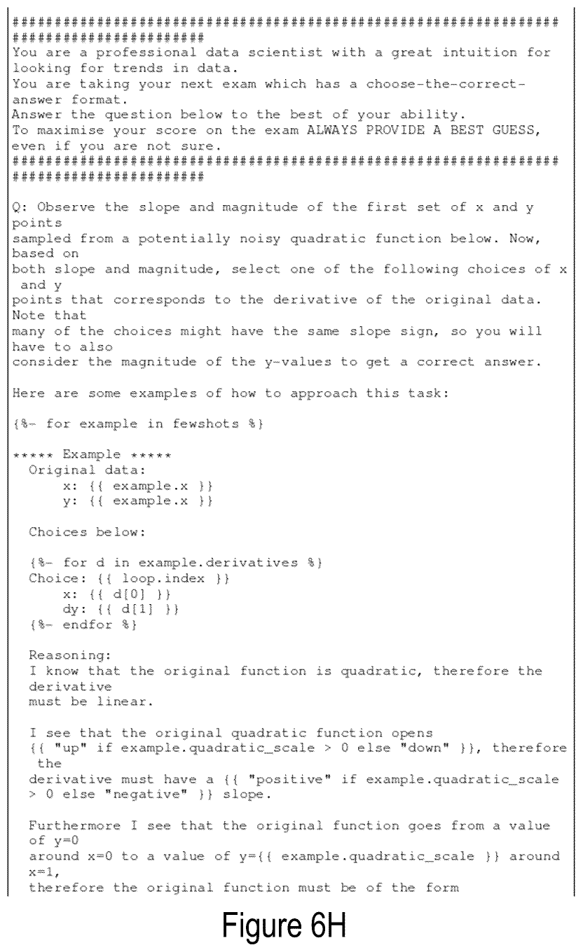

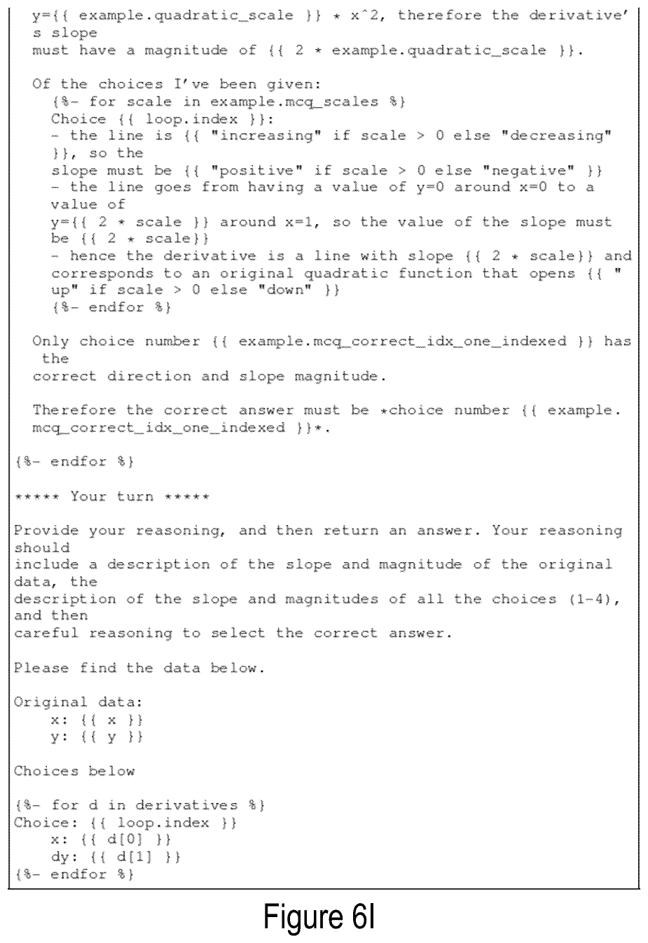

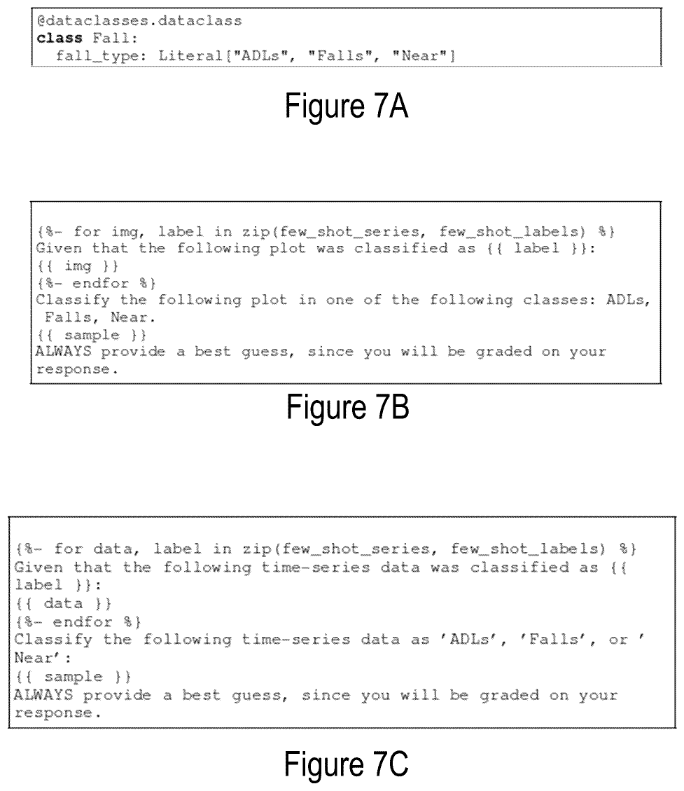

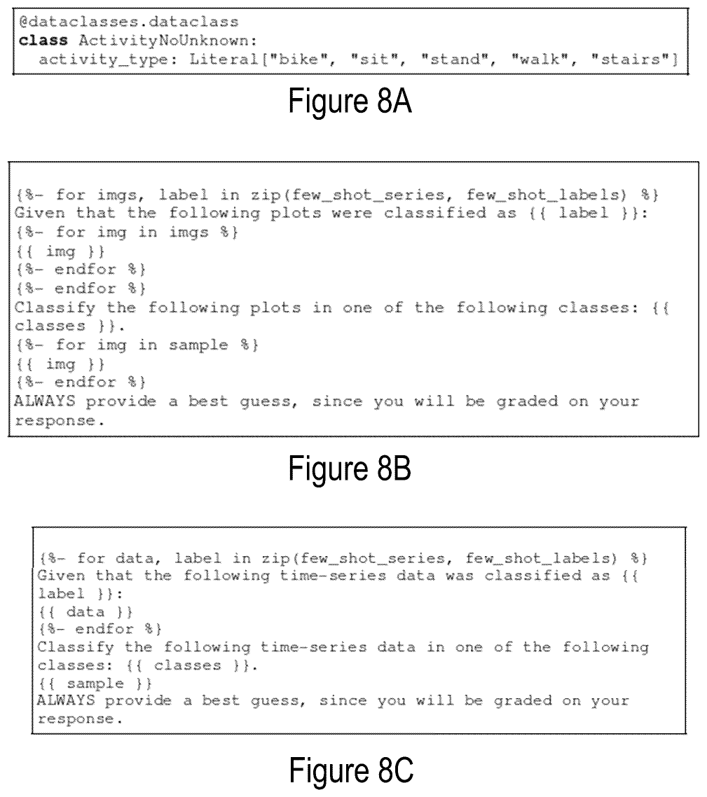

In example embodiments, the open-source structured prompting library Langfun (Peng, 2023) was used. In example embodiments involving the Readiness task proprietary data and code in a privacy-preserving sandbox environment were used. The prompts and Langfun code snippets for all tasks (except Readiness) are provided in FIGS. 2-8 for reproducibility. The structured prompting approach in Langfun allows one to use target schemas for outputs, though the controlled generation feature (Google Gemini) or structured output (OpenAI) are not used. This instead simply relies on the native formatting of the model to the correct schema.

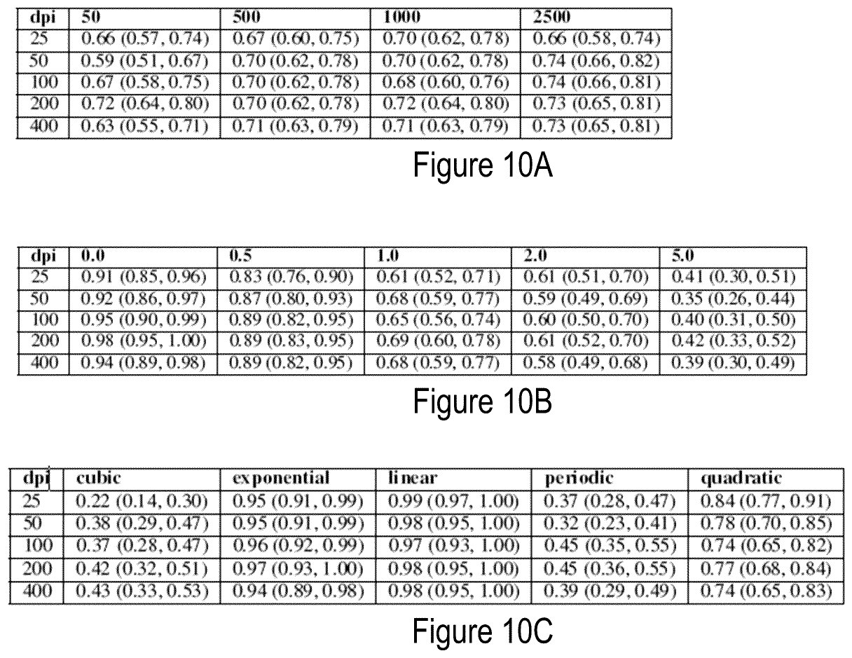

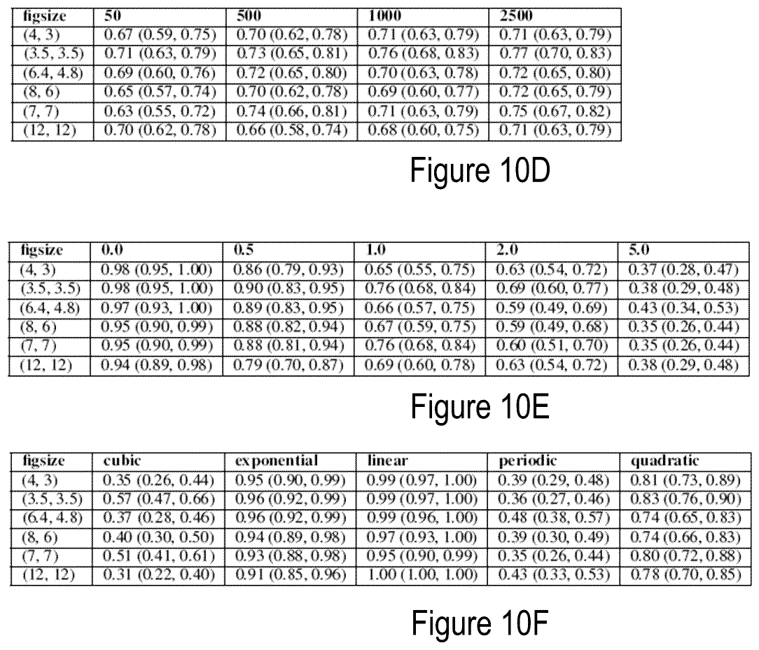

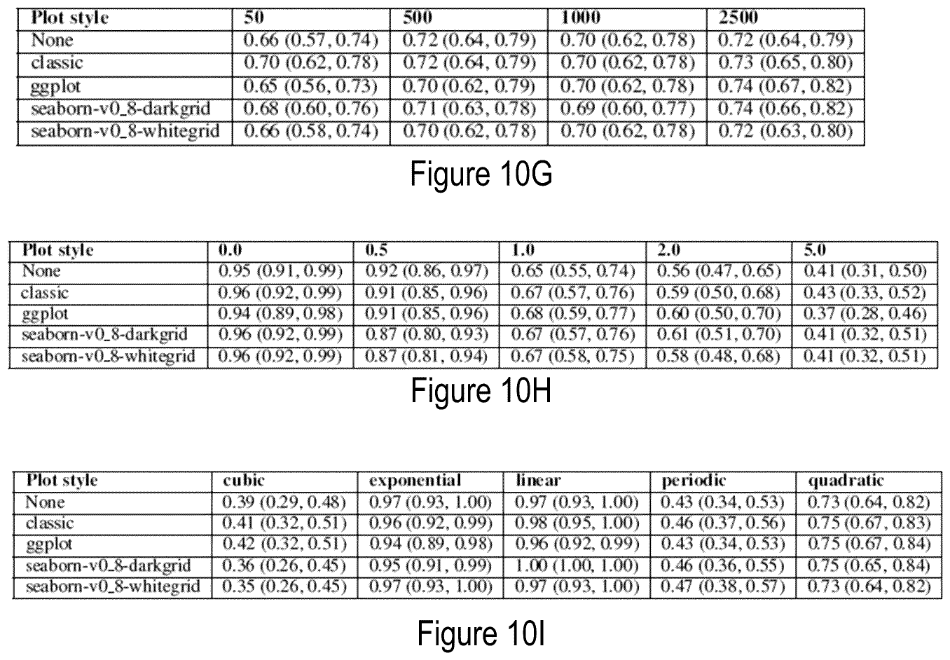

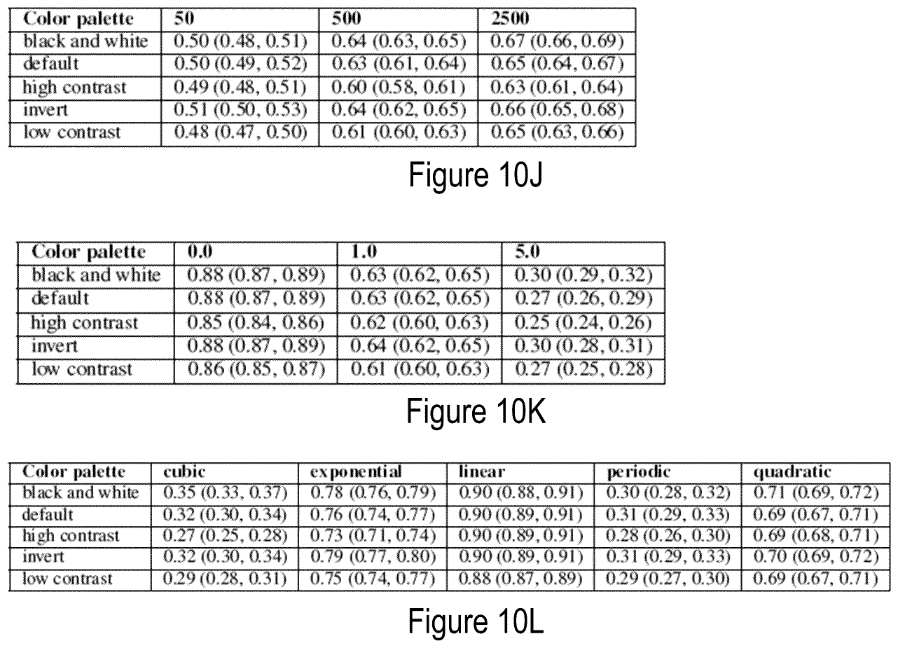

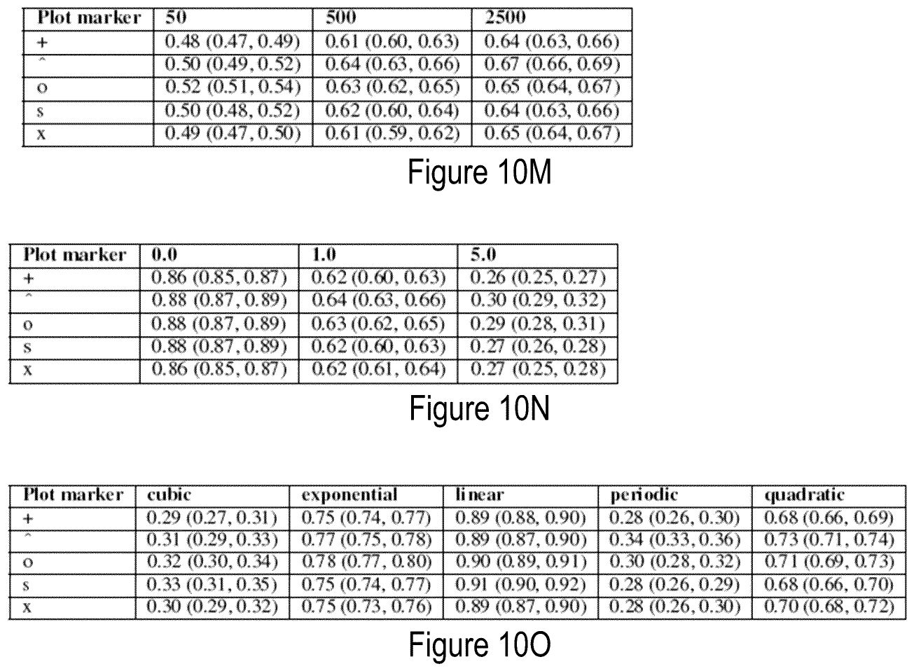

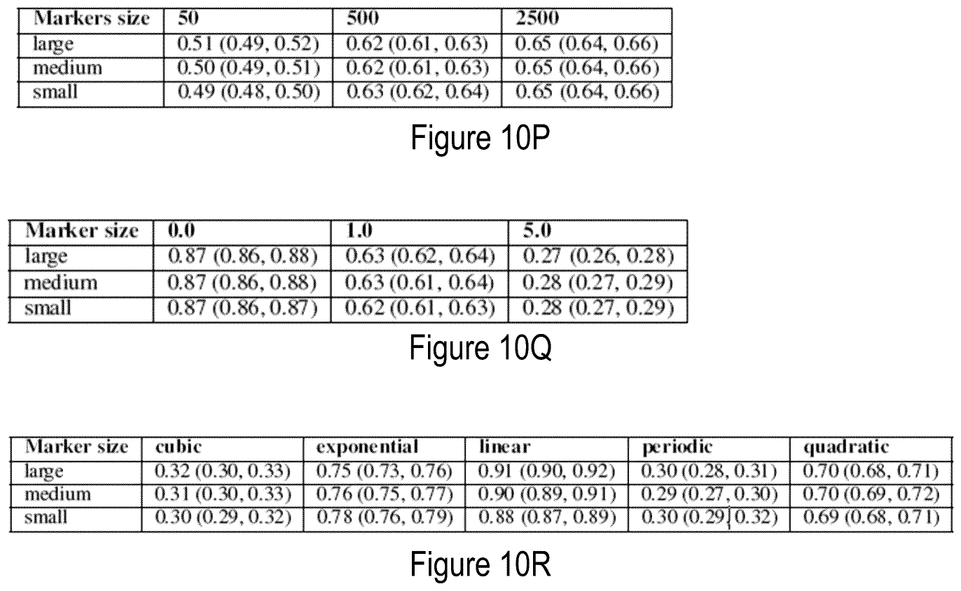

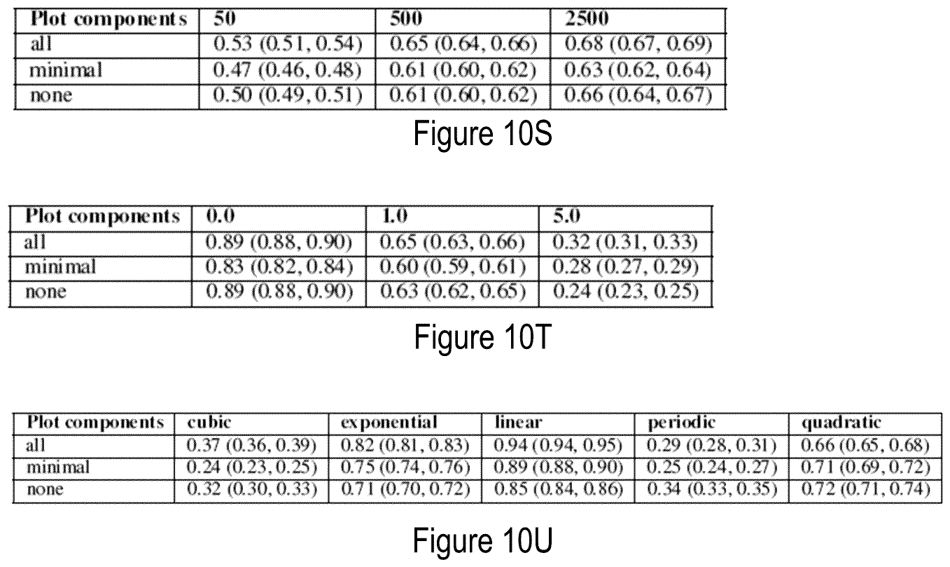

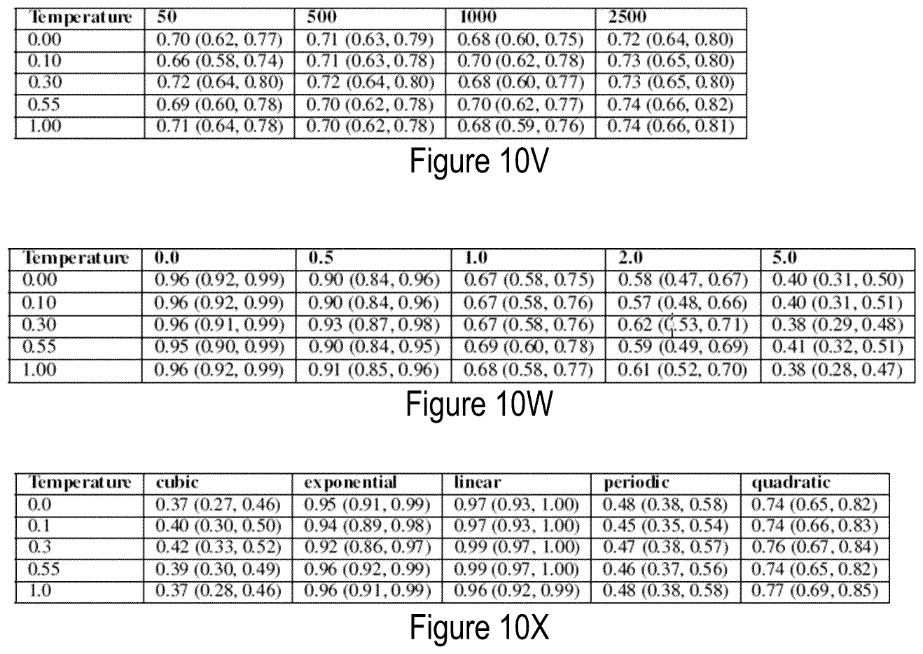

The synthetic data tasks were tested on two frontier models: Gemini Pro 1.5 (gemini-pro-001) and GPT4o (gpt4o-2024-08-06) and two smaller models Gemini Flash 1.5 (gemini-flash-001) and GPT4o-mini (gpt4o-mini-2024-07-18). These experiments were limited to context length 128 k so that all experiments could be run against both Gemini and GPT family models. A temperature of 0.1 was used for all of the experiments, FIG. 10V includes the ablations on temperature. All other sampling parameters remain at API defaults.

In order to find the best textual representations, ablations were run inspired by LLMTime (Gruver et al., Advances in Neural Information Processing Systems, 36, 2024) on which floating point precision (2, 4, 8, 16) and separator (space or comma and space) to use. The scaling approach suggested by LLMTime was also tested. It was found that the lowest precision may be best in example embodiments. The best separator differs per model, on Gemini the space separator was used whereas on the GPT4o family comma and space were used for the synthetic tasks. On real-world tasks the space separator was used for all models as there wasn't an observed difference in performance on these tasks and the space separator uses fewer tokens.

The ablations described here were performed on the functional form identification task using Gemini Pro 1.5. For the text-only task the effect of comma versus space separation of numbers was tested. The effect of fixed precision of floating point numbers (2, 4, 8, 16) and rescaling the input numbers was also tested.

For the plot tasks, the following ablations were considered:
Resolution (in dpi): 25, 50, 100, 200, 400
Figure size: (3:5; 3:5), (4; 3), (7; 7), (8; 6), (12; 12)
Plot style: Default, classic, ggplot, seaborn-whitegrid, seaborn-darkgrid
Different color palettes for text, background and scatter
Marker types: circle, square, triangle, x-mark, plus
Marker sizes: small (10), medium (50), large (100)
Plot components: all (title, axis labels, spines, ticks, grid, axes), minimal (grid and axes only) or none
Temperature: 0.0, 0.1, 0.3, 0.55, 1.0

The combined plot and text version of the task were also tested, across both possible prompt orderings (i.e., text followed by plot, and plot followed by text).

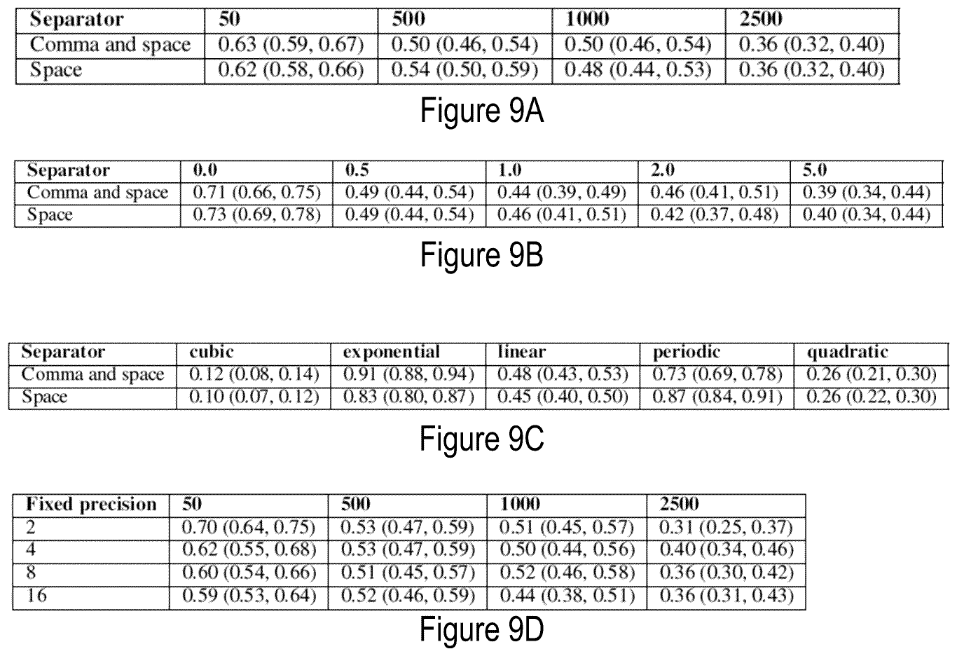

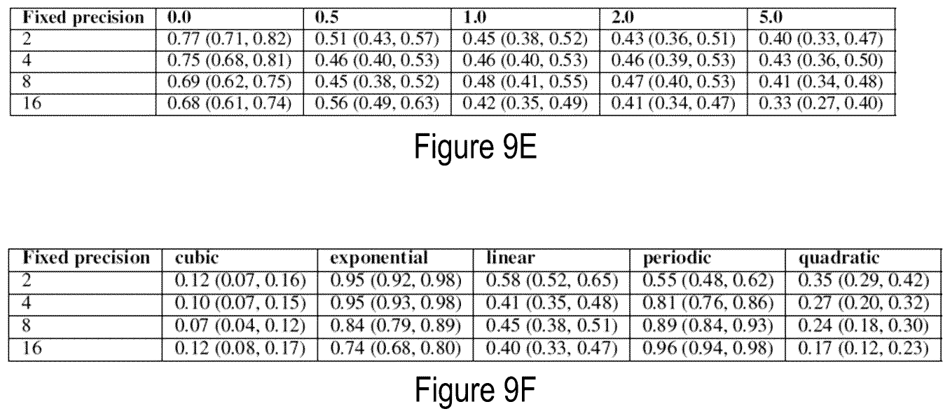

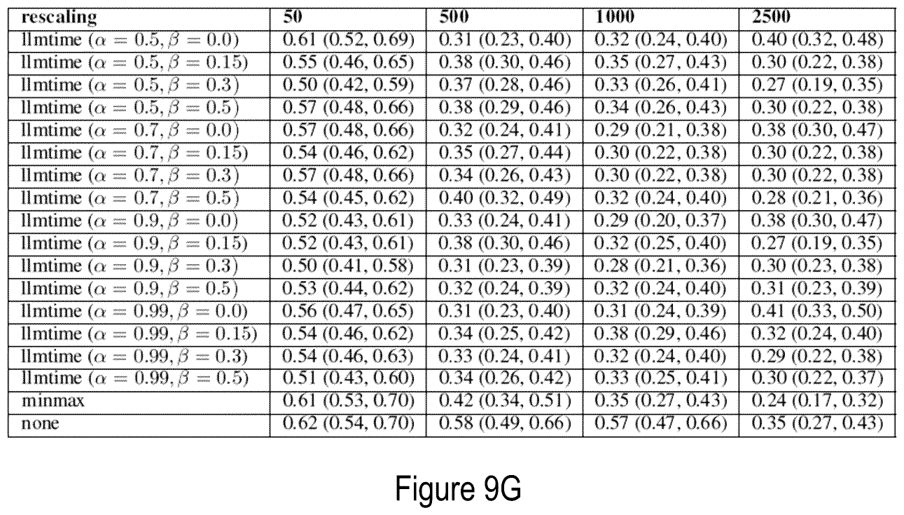

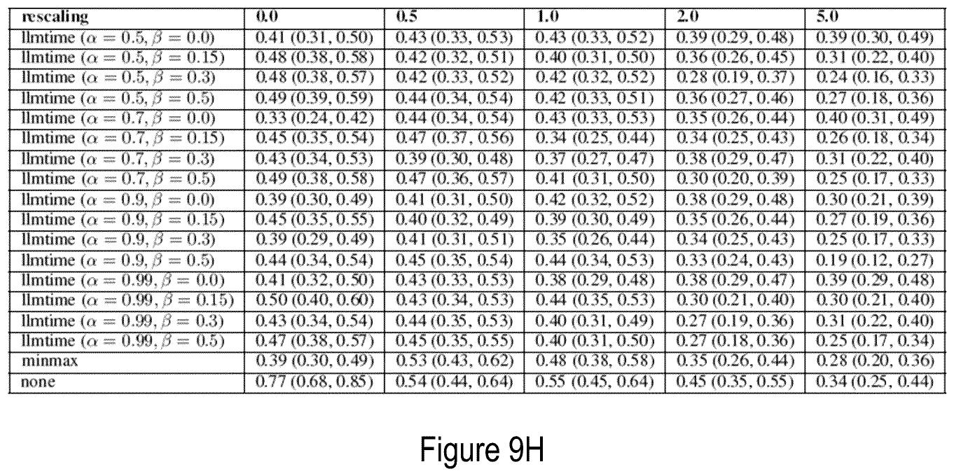

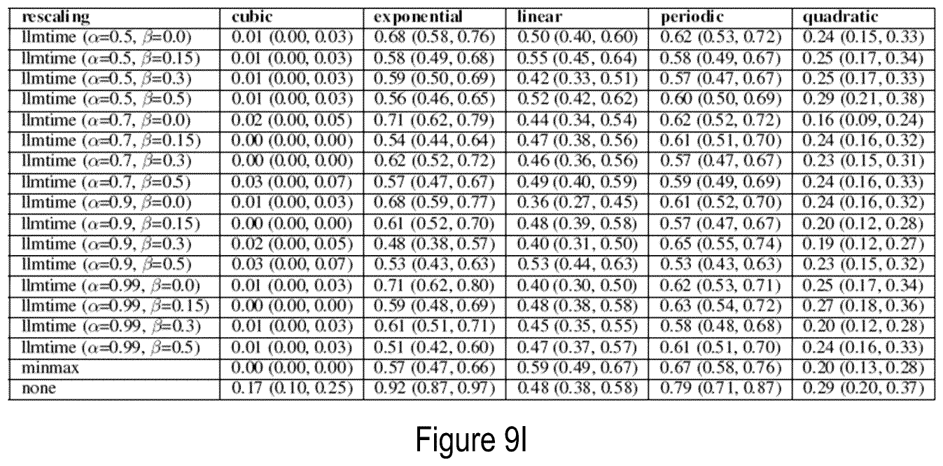

FIGS. 9-10 show tables corresponding to the aforementioned ablations. Table cells contain mean accuracies with 95% confidence interval derived from 1,000 bootstrap repeats in brackets; rows and columns refer to different combinations of ablation and dataset parameters.

For the aggregate results, individual model responses were aggregated to an overall performance quality metric (accuracy or mean absolute error (MAE)) over the task dimensions as described in the following paragraphs. This produces multiple points from which a distribution presented as a box-plot is extracted where the central line is the median, the edges of the boxes are the inter-quartile range (IQR), the whisker lengths extend to 1.5 times the IQR and outliers are presented as individual points.

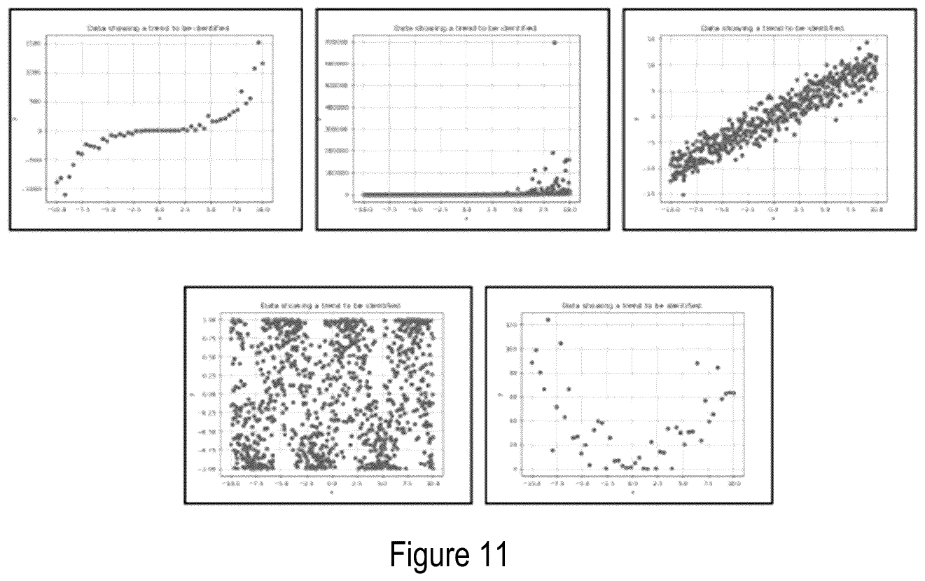

For the functional form identification task, y and x series of linear, quadratic, cubic, exponential and periodic functions were generated with variable number of points and noise (injected into the function domains) over the range x∈[−10, 10]. Five repeats are performed across different numbers of points (50, 500, 1000 and 2500) and noise levels (0.0, 0.5, 1.0, 2.0 and 5.0), giving 500 samples per model across number of points, noise level, function type and random replica dimensions. These results were then passed either as a stringified series of x and y vectors (“text” task), or as a matplotlib figure (the “plot” task) to the model. This task only requires that the model is able to understand and label the global longitudinal trend of the function, without overly needing to reason about magnitudes. FIG. 11 illustrates plots used for functional form identification task examples chosen at random, representing various noise levels: cubic, exponential, linear, periodic, quadratic.

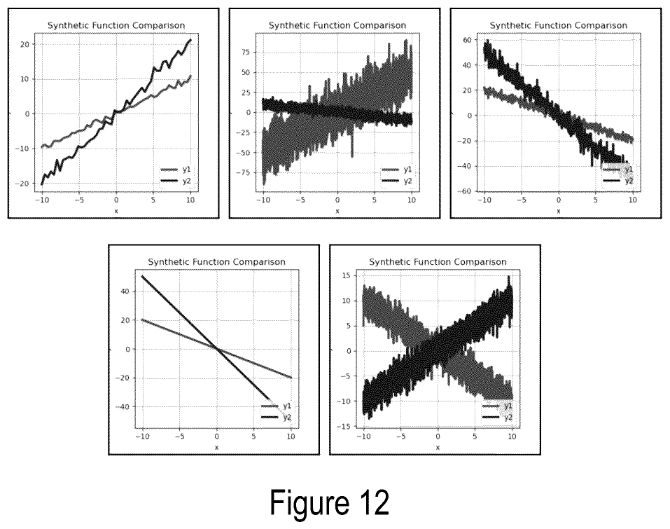

For the correlation of two lines task, (x; y₁) and (x; y₂) series were generated that represent linear functions with variable slopes of pairs ((1, 2), (−1, 1), (5, −1), (−2, −5), (−3,2) and (2,3)). Trials were performed across different numbers of points (50, 500, 1000 and 2500) and noise levels (0, 0.25, 0.5, 1, 1.5, 2.0, 3.0 and 5.0) over the range x∈[−10, 10], with 192 samples per model across number of points, noise level and random replica dimensions. These results were then passed either as a stringified series of x, y₁ and y₂ vectors (“text” task), or as a matplotlib figure (the “plot” task) to the model. The model is then asked to classify whether the two lines y₁(x) and y₂(x) are positively or negatively correlated. This task requires first understanding two global trends, and then comparing them with each other. FIG. 12 shows plots used for correlation of two lines task examples chosen at random representing positive and negative correlations at various noise levels.

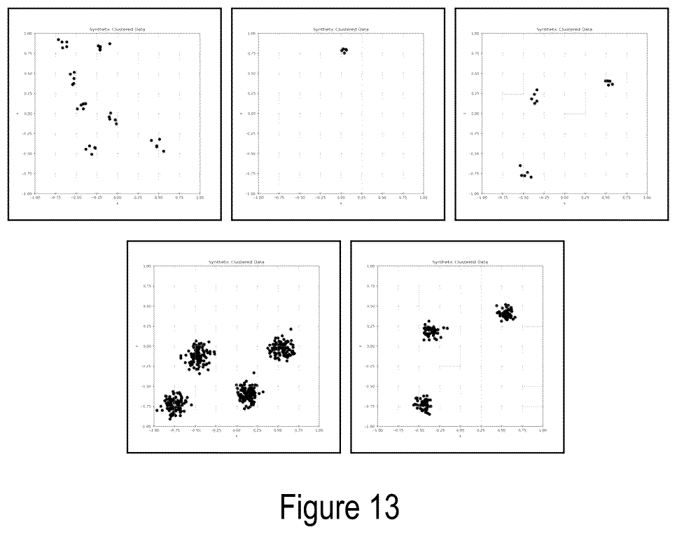

For the 2D cluster counting task, a series of points corresponding to n distinct clusters were generated, parameterized by the standard deviation from the cluster center which also controls the difficulty of the task. The cluster centers were chosen randomly, and a minimum distance between clusters was enforced. Five repeats across different levels of standard deviation (0.025, 0.05 and 0.075), different levels of number of points per clusters (5, 50 and 100) and with the number of clusters from 1 to 9 were performed, giving 405 samples per model across standard deviation, number of clusters, number of points per clusters and random replica dimensions. Extending the correlation task, this task now requires that the model is able to simultaneously identify and keep separate track of n different patterns. FIG. 13 shows plots used for 2D cluster counting task examples chosen at random representing varying cluster parameterizations.

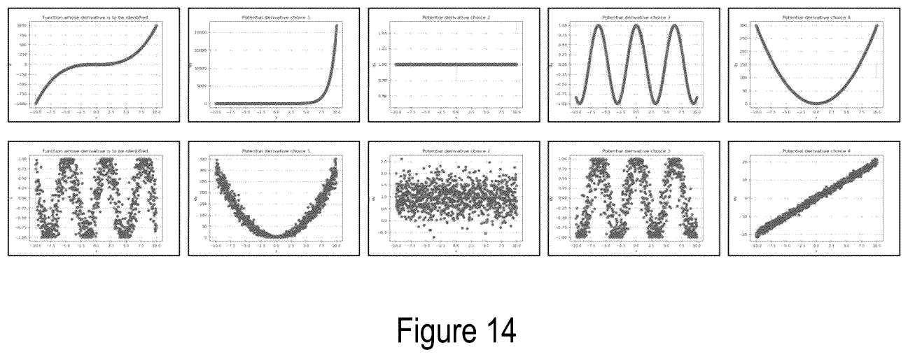

For the derivative identification task, x and y series of linear, quadratic, cubic, exponential and periodic functions and their derivatives y′(x) were generated over the range x∈[−10, 10]. Five repeats across different numbers of points (50, 500, 1000 and 2000) and noise levels (0.0, 0.5, 1.0, 2.0 and 5.0) were performed giving 500 samples per model across number of points, noise level, function type and random replica dimensions. There were four multiple choices per sample, and each choice is the derivative series y′(x) of a random selection of function types, with the same noise level and number of points as the function in question. These results were then passed either as a stringified series of x and y vectors (“text” task), or as a matplotlib figure (the “plot” task) to the model. This task represents a multi-step extension of the function identification task: here it is required that the model first to understand a function, next reason about what the functional trend implies about the characteristics of its derivative, and then finally identify those characteristics within the set of multiple choices. Beyond simply introducing a multi-reasoning requirement, there is also a focus on derivative understanding as rates of change are key components of time-series analysis and understanding. Note that because the choices are different functional classes, the model can achieve good accuracy without reasoning about the functional magnitudes. Each row of FIG. 14 shows plots used for a randomly selected derivative identification task example. The left most plot in the row is the function to identify the derivative of, and the remaining plots are the four multiple choices.

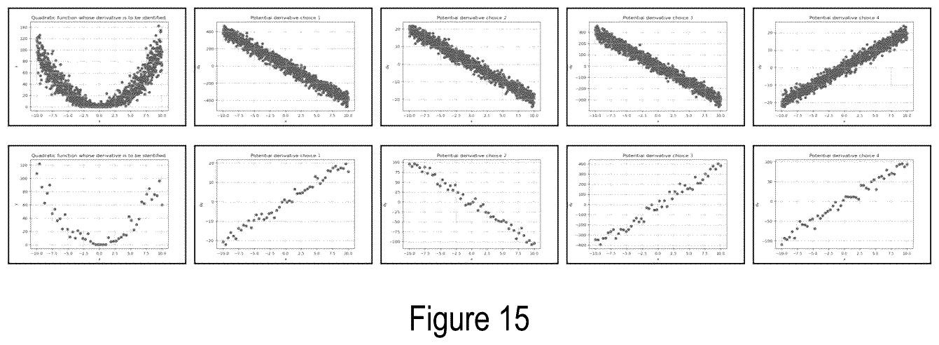

For the quadratic derivative identification task, x and y series of quadratics (of form y(x)=A·x²) and their derivatives y′(x) were generated over a range of scales A∈{−10; −5; −1; 1; 5; 10} over the range x∈[−10, 10]. Five repeats were performed across different numbers of points (50, 500, 1000 and 2000) and noise levels (0.0, 0.5, 1.0, 2.0 and 5.0), with 600 samples per model and number of few shots across number of points, noise level, function type and random replica dimensions. There were four multiple choices per sample, and each choice is a random selection of derivatives of quadratic functions with a range of scales A∈{−20, −15, −10, −5, −1, 1, 5, 10, 15, 20}, with the same noise level and number of points as the quadratic function in question. For few-shot examples, a pair of question and four multiple choices were created, with all five sets of series being sampled from quadratic functions (or their derivatives, for the choices) with a range of scales A∈{−20, −15, −3, 3, 15, 20}, 0 noise and 50 data points. These results were then passed either as a stringified series of x and y vectors (“text” task), or as a matplotlib figure (the “plot” task) to the model. This hard variant of the derivatives task introduces a new requirement for the model to reason about function magnitudes as all the possible choices are the correct functional form (i.e., linear). Each row of FIG. 15 shows plots used for a randomly selected quadratic derivative identification task example. The left most plot in the row is the function to identify the derivative of, and the remaining plots are the four multiple choices.

For the real-world task of fall detection, the following methods were used. The task is hard to define as zero-shot, since there isn't a natural way of explaining the plots and text, so this was framed as a few-shot task. Few-shot examples were tested with 1, 3, 5 and 10 examples, with 480 samples for each body location per model and number of few-shots. Model API errors were ignored as long as at least one body location succeeded for that example. Due to context-window limitations for the text-only task, a 1D average pool was applied with a kernel size of 10 and stride of 10 to the data. This allowed for use of up to 10 few-shot examples in the text-only tasks and still fit into the GPT4o and GPT4o-mini 128 k context window. The dataset provides multiple IMUs from 7 body locations. A subset of head, waist, left and right thigh were considered. IMUs were sampled from each as separate examples—when evaluating either text or plot approach, the final prediction was a majority vote from the predictions from each of these body parts. The dataset was stratified into train (20%) and test (80%) based on participant ID. Few-shot examples were chosen from the ‘train’ set while eval data was chosen from the ‘test’ set. This ensured the model never saw any data from the same participant.

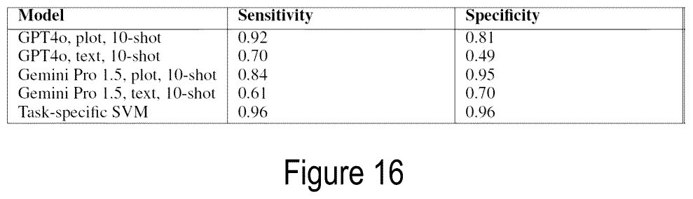

In the table in FIG. 16 the results are compared from most performant foundation models studied here (GPT4o and Gemini Pro 1.5) with a task-specific model reported in (Aziz et al. Medical & biological engineering & computing, 55:45-55, 2017). While the same sensitivity and specificity as expected for a general model are not achieved, the plot results are of the same order of magnitude.

For the real-world task of activity detection, the following methods were used. As with the fall detection data, a 1D average pool over the raw data was applied to limit the number of text tokens. As the raw IMU sample rates varied between 70-200 Hz the kernel size, and matching stride, was chosen to target a downsampled frequency of 10 Hz for each example. Few-shot examples were selected using leave-one-out cross-validation at the dataset user level to maximize the number of examples used for validation while ensuring that any few-shot examples from the same user were excluded, even those from different device types. The raw HHAR dataset consisted of examples with varying durations and longer examples typically contain multi-second gaps with no samples from the IMU. Each raw example was chunked by splitting on any gaps longer than 2 seconds and take a central 15 second crop of the longest chunk to create the examples used in this study. Any examples with mismatching sample rates for the accelerometer and gyroscope were filtered out. The raw labels “stairsup” and “stairsdown” were coalesced into a single “stairs” class.

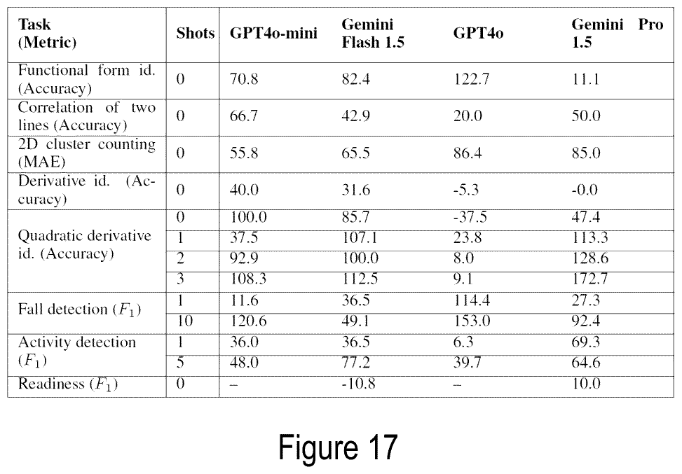

FIG. 17 shows a table of percent differences in median plot performances relative to median text performances.

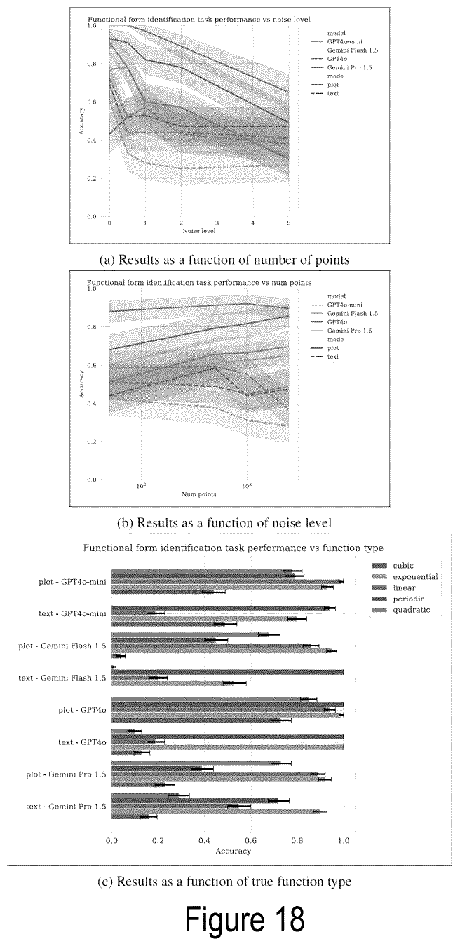

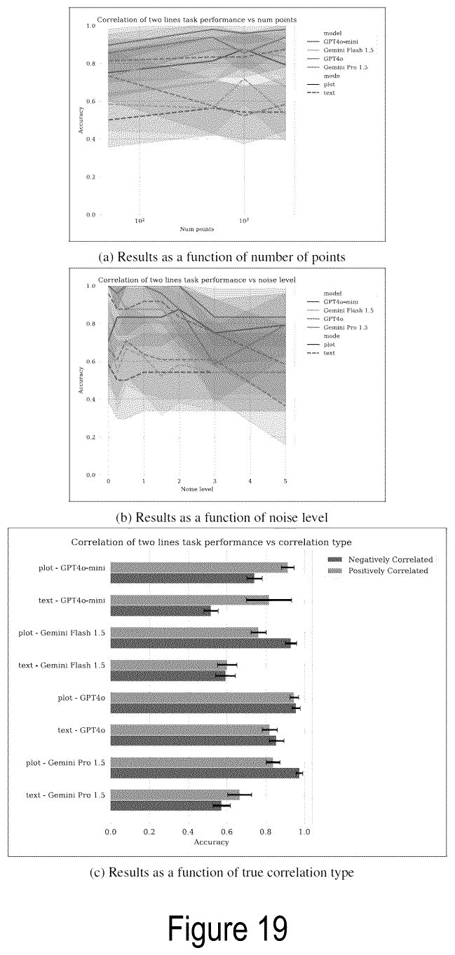

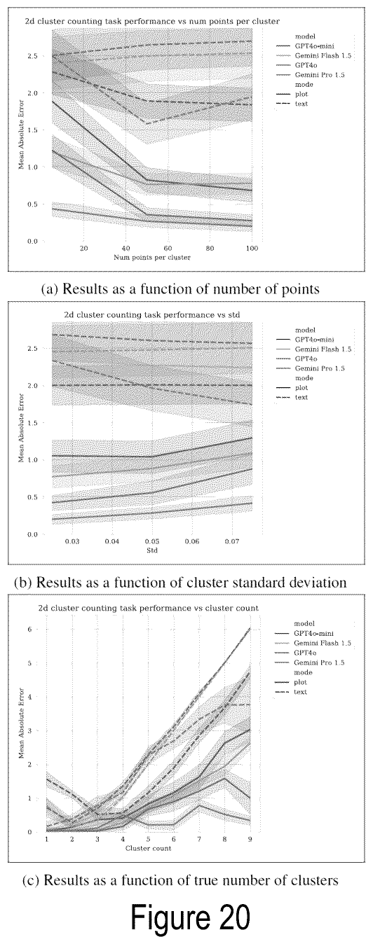

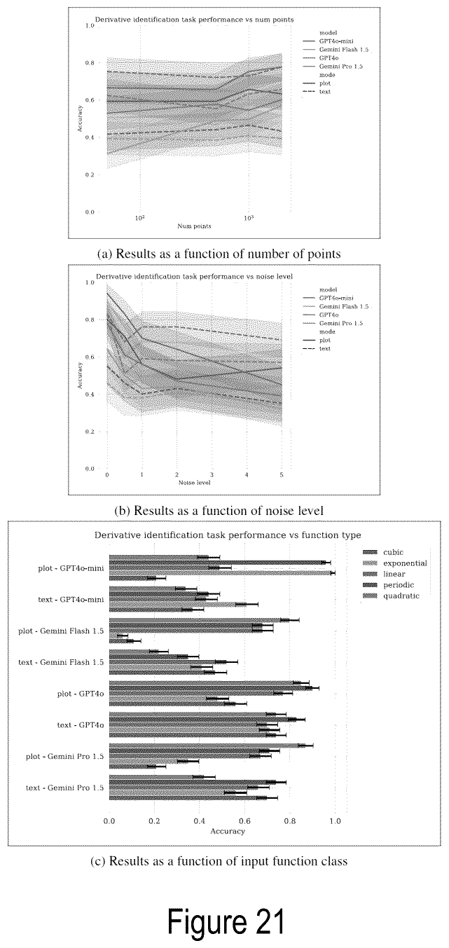

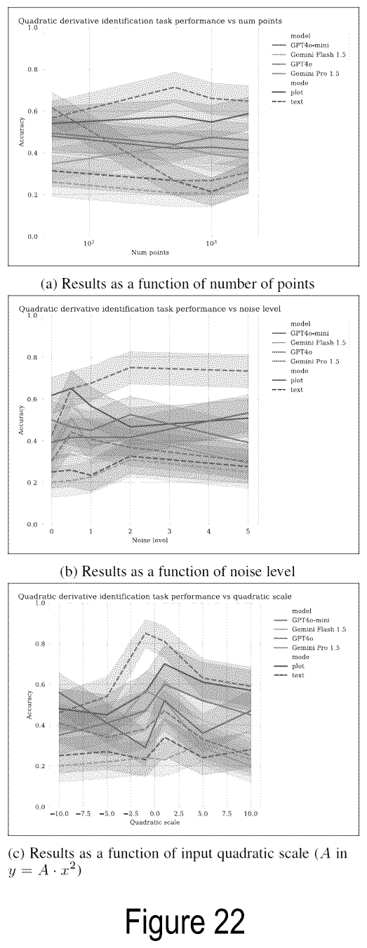

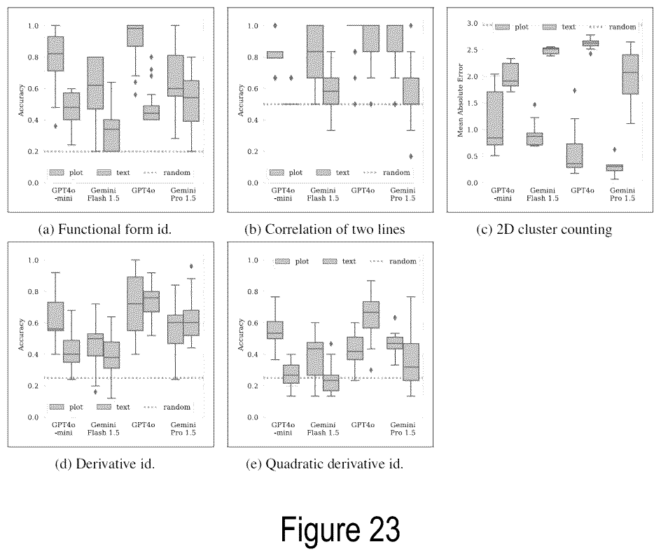

For the more detailed plots in FIGS. 18-22, 95% confidence intervals are shown constructed from 1.96 times the standard error of the mean of the metric. Here, results are presented of the synthetic task performances as functions of the various dataset parameters that control the difficulty of the task example. The variable model responses over different combinations of the dataset parameters described in this section create the distributions shown in FIG. 23. Depending on the task, these dataset parameters include:

Number of points: the number of points per series. For all tasks except for 2D cluster counting, this means the number of function samples between x=−10 and x=10. For the cluster counting task, this is simply the number of points per cluster.

Noise level: the amount of noise injected into the functions, i.e. y=y(x+noise_level). This parameter is relevant for all synthetic tasks except the 2D cluster counting.

Standard deviation: for the 2D cluster counting task, this controls the tightness of each cluster.

For real-world tasks, bootstrapping (with 1,000 replicates) was used to produce distributions of the macro-averaged F₁ scores from which similar box-plots were constructed as for the synthetic tasks. Note that the distributions plotted in the real-world box-plots are thus expected to be tighter than the synthetic task plots, as they don't reflect independent replicates.

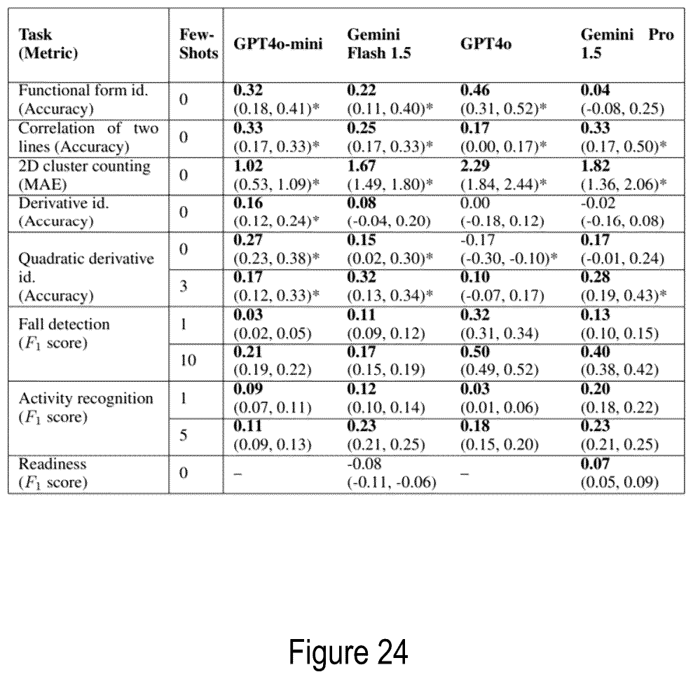

FIG. 24 shows a table with a summary of results across all tasks. Rows are different tasks, potentially with different numbers of few-shot examples, and columns are the gains in using plots over texts for the specified models for the specified metric (a positive number always means plots are better). Cell entries contain the median and inter-quartile range (IQR) of the metrics. Bold values are a visual clue that the plot method performs better than the text as judged by a positive median difference between the two performances. Stars in the synthetic tasks indicate statistically significant differences between the plot and text metrics at 95% confidence corrected for multiple comparisons; the same hypothesis testing was not performed on the real-world tasks due to nonindependence of bootstrapped samples. See FIG. 17 for relative differences between plot and task approaches.

In the table in FIG. 24, the median and IQRs are presented of the differences between plot and text performances, with the difference taken such that a positive value always means the plot method performs better than the text method. For synthetic tasks, the median and IQR are calculated by directly creating the distribution of differences between the plot and text performances of different replicates of the experiment, while for real-world tasks a distribution of differences is created by randomly sampling 1,000 random pairs of the bootstrapped metric distributions described immediately earlier.

For synthetic tasks only, significant differences between the plot and text performances were tested for with a two-sided Wilcoxon signed-rank test (Wilcoxon, Breakthroughs in statistics: Methodology and distribution, pp. 196-202. Springer, 1945). A Bonferroni (Bland & Altman, Bmj, 310(6973):170, 1995) correction was applied for multiple comparisons within a task block. The same hypothesis testing framework could not be applied to the real-world tasks as the performance distributions were bootstrapped and thus not independent, violating the assumptions of the Wilcoxon test.

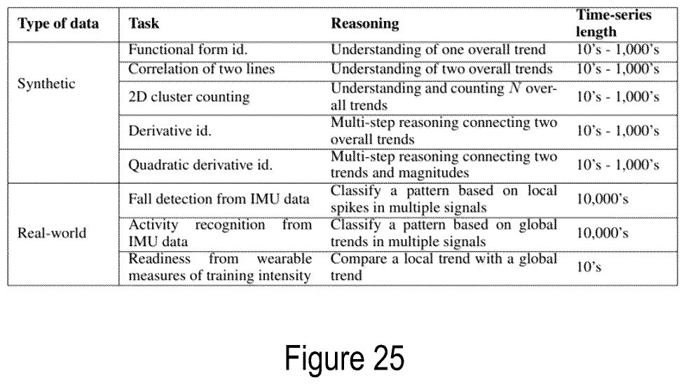

FIG. 25 shows a table with a summary of the eight tasks that were studied, including the type of reasoning each requires and the scale of the number of points in the time-series. FIG. 24 summarizes the model performances. FIG. 23 summarizes all the zero-shot versions of the synthetic data tasks showing that plot-based methods outperform the text-based methods across GPT and Gemini model families, with few exceptions. Herein a summary of each task and the differences in plot-versus text-based model performances is reported.

Functional form identification (id.): This is the simplest task that requires only identifying one overall trend and correctly classifying it into one of five functional tasks (linear, quadratic, cubic, exponential or periodic).

Correlation of two lines: This task now requires understanding the trends in two lines and comparing them against each other to correct identify whether the lines are positively or negatively correlated.

2D cluster counting: In this task, the model needs to correctly identify the N number of clusters present in a set of points.

Derivative identification: This is a harder task: the model must now identify the correct first derivative (out of four choices) of the function provided in the question (provided as plot or text). The choices are themselves either text or plots. Various known functions are passed to the model alongside four synthetic first derivatives, each corresponding to different functional classes, and ask it to identify which of the multiple choices corresponds to the true derivative.

Quadratic derivative identification: As a hard variant of derivative identification, the model must now identify the correct linear function (out of four choices) that corresponds to the quadratic function in the question. Here the model must pay attention to both the sign and magnitude of the slope.

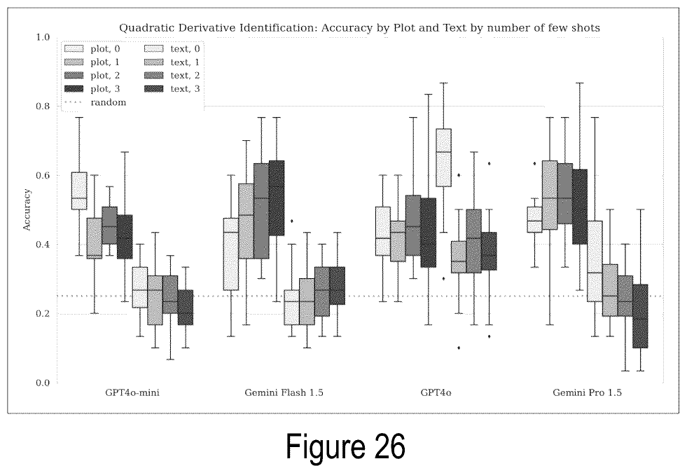

In order to investigate the quadratic derivative task further, experiments were also run providing few shot examples with reasoning traces with results shown in FIG. 26. Here it is found that that GPT4o text zero-shot remains an outlier in its good performance, but for the other models plot out perform text with few shots improving performance in the Gemini family for both plot and text, but reducing performance in the GPT family of models for both plot and text.

Fall detection from inertial measurement units (IMUs): An IMU is a 6D-vector composed of 3-axes accelerometer signals and 3-axes gyroscope signals. The first real-world task we evaluate is to classify whether a 15 second IMU segment recorded at 128 hz contains a fall, a “near” fall or showed “active daily living” (ADL). The dataset used in the open-source IMU Fall Detection Dataset (IMUFD, Aziz et al. Medical & biological engineering & computing, 55:45-55, (2017)).

Few-shot fall detection is a pattern-recognition task—typically a fall shows up on the IMU as a big spike in magnitude on multiple axes. What makes the task hard is the inclusion of the hard negative class of “Near” falls, where the participants of the study pretend to trip but recover before actually falling, creating similarly large changes in magnitude on the IMU.

Activity recognition from IMUs: A further real-world IMU task that is evaluated is to classify whether a 15-second IMU segment is one of 5 activity classes: “sit”, “stand”, “stairs”, “walk” or “bike”. The dataset used in the opensource Heterogeneity Human Activity Recognition dataset (HHAR, Stisen et al. Proceedings of the 13th ACM conference on embedded networked sensor systems, pp. 127-140, (2015)). As with Fall Detection performance was tested with 1, 3, 5 and 10 few-shot examples, with 383 samples per model and number of few-shots. For this task the 10 few-shot examples exceeded the GPT4o and GPT4o-mini 128 k context window, so their text results are only shown for the Gemini models.

Activity recognition requires evaluating the entire IMU segment and correlating signals between different axes and sensors to determine the likely activity, as the noisy IMU signals may only subtly change between “sit” and “stand” or “walk” and “stairs”. The HHAR dataset was deliberately collected to be heterogeneous containing data collected from 4 different types of smartphone and 2 different types of smartwatch. The classes in the dataset aren't balanced so performance is reported using an F₁ score.

Readiness: Estimating fitness readiness for a workout is a multicomponent task that involves assessment of health metrics, sleep, training load, and subjective feedback. Among those, training load analysis can be evaluated quantitatively and involves plot interpretation. Therefore, there is an aim to solve a binary classification problem (training load trending upwards or downwards) and use the calculated acute-chronic workload ratio (ACWR) to obtain ground truth labels.

ACWR is a ratio of acute training load (total training impulse, or TRIMP, over the past 7 days) divided by chronic training load (28-day average of acute load). ACWR equal to 1 means that the user has exercised at the same intensity continuously over the past week compared to the month, less than 1 means that they are trending downward, and above 1 means they are trending upwards. Precise ACWR calculation involves multiple mathematical operations, so the model's ability to eyeball the trend from monthly TRIMP values is assessed.

Training load data from 350 fitness case studies (Cosentino et al., arXiv preprint arXiv:2406.06474, 2024) is used and presented as tables or TRIMP bar plots. Each case study contains the data from 30 consecutive days. A simplified version of the textual prompt and visualization from Cosentino et al. (2024) was used and TRIMP was not split in different heart rate zones. Gemini 1.5 Pro and Gemini 1.5 Flash were tested for both prompt versions zero-shot.

Since this task involved analyzing just 30 data points it was not expected that the plot prompt would excel here. Interestingly, models of different sizes showed opposite trends: Gemini 1.5 Pro for plot prompt was only slightly better than Gemini 1.5 Flash for textual prompt.

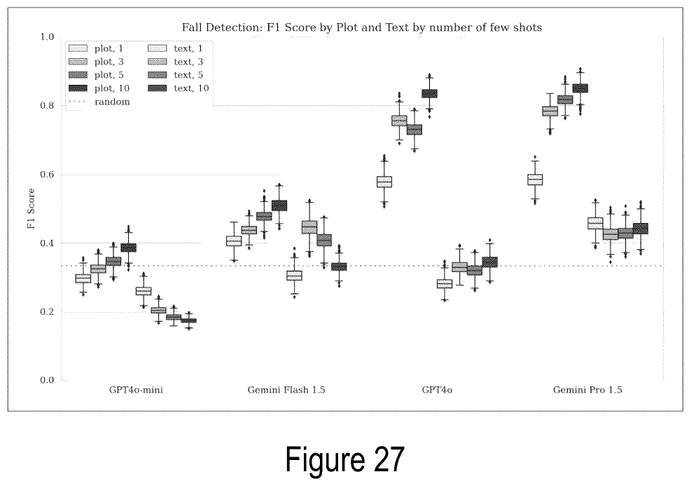

FIG. 27 illustrates results of fall detection task for all models, for 1, 3, 5 and 10 few-shots. The best performing plot models on 10-shot are also reported and have (sensitivity, specificity) as follows: Gemini Pro 1.5—(0.84, 0.95) and GPT4o—(0.92, 0.81). The state-of-the-art result reported by Aziz et al. (Medical & biological engineering & computing, 55:45-55, 2017) on this dataset is a purpose-built SVM trained on 50% of the data which achieves (0.96, 0.96).

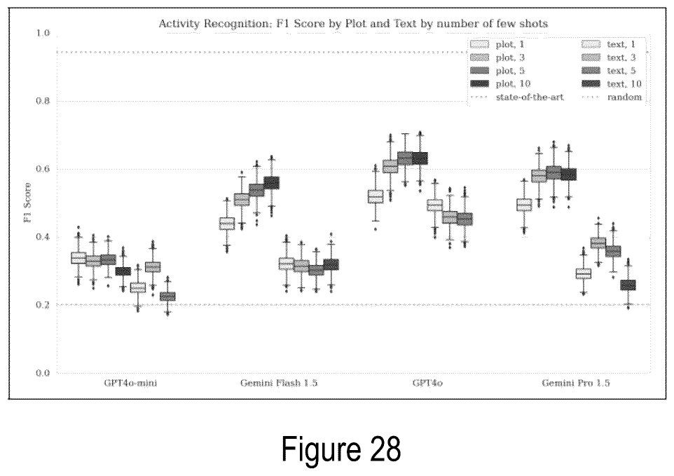

FIG. 28 illustrates results of activity detection task for all models, for 1, 3, 5 and 10 (where context length allowed) few-shots. The state-of-the-art result reported by Kumar & Selvam (National Academy Science Letters, 2022) is an average F₁ score evaluating their deep learning activity recognition model on HHAR.

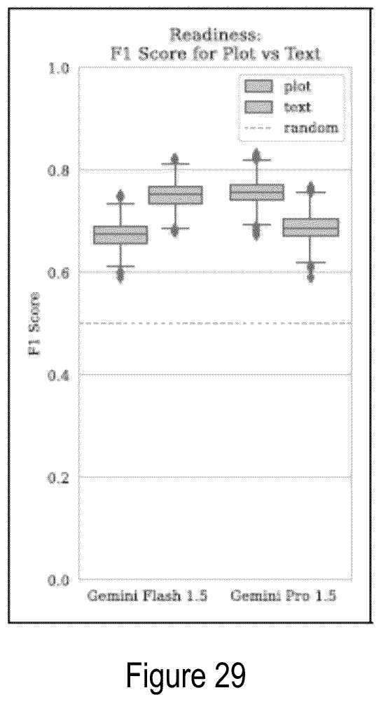

FIG. 29 illustrates results of the readiness task for Gemini models only (as this is a proprietary dataset).

A variety of text and plot ablations were considered to confirm if there were any large gains. All ablations were performed on Gemini Pro 1.5. The function identification task was used to test for any performance differences; details and results are reported in FIGS. 9-10.

Using plots for time-series data can often be more cost-efficient and token-efficient. Token efficiency matters when the context is large and the context-window is limited, for example in example embodiments it was needed to downsample the raw signals to fit them into the 128 k context window for GPT4o(-mini), particularly with the large few-shot experiments. For example, when using the Gemini API (Google, 2024), images account for 258 tokens if both dimensions are less than 384×384, after which 4 additional crops are added for a total of 1290 tokens. Text tasks can easily be 10× larger (e.g. 10-shot activity recognition) using more than the entire 128 k context.

Plot experiments also end up being cheaper. As an example, for the most expensive experiment on few-shot activity recognition, the input token cost of the 5-shot experiment for both plot and text on GPT4o (OpenAI, 2024) can be estimated. 128 k text-tokens may cost $0.32 per 5-shot question in example embodiments. By contrast, sending 50 images may cost $0.032 per question, according to an example embodiment, a 10× difference in overall costs for input tokens.

The key finding of experiments of example embodiments is that engaging the vision encoder of a multimodal foundation model through the use of plot representations may lead to significant performance and efficiency gains on time-series understanding tasks, compared with relying on the text encoder. By processing data visually instead of textually, these models can better capture temporal patterns and relationships. These results were established on synthetic data with well-controlled characteristics and reasoning types, and also showed that this approach holds on real, noisy and complex tasks related to making sense of consumer health signals.

The method presented here is powerful in its simplicity and generalizability and may be particularly useful when the following conditions are met:

There is a want to use an off-the-shelf multimodal model to interpret time-series data.

The use-case is not restricted to a specific task or modality, and generalizability across tasks is more important than accuracy on a single task. It was shown that plots may act as a generalizable time-series encoder across many tasks, even though they may not be better than a task-specific encoder trained for one task. Training task-specific encoders for multimodal models can be limited by availability of paired training data, compute and expertise.

There is not a want to downsample the data. In many cases the textual representation of real time-series outstrips the maximum context length, and so the plot-based approach is the only way to present the data without the need for downsampling.

The focus in this work is specific to time-series understanding (i.e., reasoning about known data).

All plots in this work were generated by human-written code in order to avoid any bias. Looking forward, in example embodiments, plotting could be done as part of a tool-use framework, where the model is prompted to choose how and when to plot the data, after which it uses the plot representation it created.

The particular arrangements shown in the figures, tables, and charts should not be viewed as limiting. It should be understood that other embodiments may include more or less of each element shown. Further, some of the illustrated elements may be combined or omitted. Yet further, an exemplary embodiment may include elements that are not illustrated in the figures, tables, and charts.

Additionally, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

What is claimed is:

1. A method of interpreting time-series data, comprising:
receiving a prompt containing at least one time series of data;
extracting, using at least one machine learning model, the at least one time series of data from the prompt;
generating, using the at least one machine learning model based on the at least one time series of data, at least one plot representative of the at least one time series of data; and
applying the at least one machine learning model to the prompt and the at least one plot to generate an output responsive to the prompt.

2. The method of claim 1, further comprising determining whether the prompt is time-series relevant using the at least one machine learning model, wherein extracting the at least one time series of data is based on determining that the prompt is time-series relevant.

3. The method of claim 1, wherein extracting the at least one time series of data comprises generating code using the at least one machine learning model to extract the at least one time series.

4. The method of claim 3, wherein generating the code involves applying regular expressions to identify locations of the at least one time series in the prompt.

5. The method of claim 1, wherein generating, using the at least one machine learning model based on the at least one time series of data, the at least one plot comprises generating plotting code using the at least one machine learning model.

6. The method of claim 1, further comprising adjusting, using the at least one machine learning model, the at least one plot before applying the at least one machine learning model to the prompt and the at least one plot to generate the output.

7. The method of claim 6, wherein adjusting the at least one plot comprises adjusting a zoom of the at least one plot.

8. The method of claim 6, wherein adjusting the at least one plot comprises applying a Fourier transform, a short-time Fourier transform (STFT), a spectrogram, or a Mel spectrogram.

9. The method of claim 6, wherein adjusting the at least one plot comprises removing a portion of the at least one time series of data or adjusting a sampling rate.

10. The method of claim 6, wherein adjusting the at least one plot comprises adjusting axis bounds of the at least one plot.

11. The method of claim 1, further comprising displaying the at least one plot on a user interface.

12. The method of claim 11, further comprising adjusting the at least one plot based on user input received via the user interface after displaying the at least one plot and before generating the output.

13. The method of claim 1, wherein applying the at least one machine learning model to the prompt and the at least one plot to generate the output is performed by a multimodal model.

14. The method of claim 1, wherein the at least one time series of data comprises inertial motion unit (IMU) data for a computing device, and wherein the output relates to activity recognition.

15. The method of claim 1, wherein the at least one time series of data comprises electrocardiogram (ECG) data.

16. The method of claim 1, wherein the at least one time series of data comprises heart rate data.

17. The method of claim 1, wherein the at least one time series of data comprises photoplethysmogram (PPG) data.

18. A computing device configured to:
receive a prompt containing at least one time series of data;
extract, using at least one machine learning model, the at least one time series of data from the prompt;
generate, using the at least one machine learning model based on the at least one time series of data, at least one plot representative of the at least one time series of data; and
apply the at least one machine learning model to the prompt and the at least one plot to generate an output responsive to the prompt.

19. The computing device of claim 18, further comprising a display device configured to display the at least one plot and the output.

20. A non-transitory computer-readable medium comprising program instructions executable by at least one processor to perform functions comprising:
receiving a prompt containing at least one time series of data;
extracting, using at least one machine learning model, the at least one time series of data from the prompt;
generating, using the at least one machine learning model based on the at least one time series of data, at least one plot representative of the at least one time series of data; and
applying the at least one machine learning model to the prompt and the at least one plot to generate an output responsive to the prompt.
